(19) United States
(12) Patent Application Publication
(10) Pub. No.: US 2008/0085439 A1
(43) Pub. Date: Apr. 10, 2008

(54) Solid oxide electrolytic device

(76) Inventor: Donald Bennett Hilliard, El Granada, CA (US)

Correspondence Address: Donald Hilliard, P.O. Box 2025, El Granada, CA, 94018, US

(21) Appl. No.: 11/906,044

(22) Filed: Sep. 28, 2007

Related U.S. Application Data
(60) Provisional application No. 60/847,719, filed on Sep. 28, 2006.

(51) Int. Cl. H01M 8/10; C25B 9/00

(52) U.S. Cl. 429/30; 204/194; 427/115

(57) ABSTRACT

An interconnect structure is disclosed for use in solid oxide electrolytic devices that use chrome-containing components, such as solid oxide fuel cells and solid oxide oxygen-generators. The invention provides a reliable and durable interconnect for both structural and electrical components of such devices. In general, the interconnect structure relies on a dual-layer, high-temperature seal which provides an effective diffusion barrier for both chrome and oxygen. As a result of the described interconnect, corrosion or loss in electrical conductivity in such solid oxide electrolytic devices is avoided. Also, a novel structure for such solid oxide electrolytic devices is disclosed, which provides an economical and high-integrity structure that utilizes the disclosed interconnect structure. A result of the present invention is that thin film solid oxide fuel cells and solid oxide oxygen generators may be fabricated using only metal alloys as bulk components.

### FIELD OF THE INVENTION

This application is related to U.S. provisional application Nos. 60/371,891 and 60/847,719, and U.S. patent application Ser. Nos. 10/411,938, and PCT application US2005/046311. The present invention relates in general to solid oxide electrolytic devices, including solid oxide fuel cells (SOFC's), oxygen generation systems (OGS'), gas separation systems, gasification systems, and novel interconnect structures in such devices. In particular, the invention relates to the use of chrome-containing alloys in these devices, and the use of protective layers deposited to prevent corrosion, degradation, and/or increased electrical resistivity of the alloys.

### BACKGROUND OF THE INVENTION

### Description of the Related Art

Solid state devices based on high-temperature (>500° C.) solid oxide electrolyte behavior have become increasingly important for a variety of applications. Such devices are of interest as viable options for power generating fuel cells, as well as for producing pure oxygen, hydrogen, and other such gases that may be produced through dissociation of oxygen-bearing gases. Potential applications of the preferred embodiments are portable, stationary, automotive, uninteruptible power supplies (UPS), auxiliary power units (APU), coal gasification and syngas utilization; power output from resulting devices may be sub-kilowatt to multi-kilowatt.

### SUMMARY OF THE INVENTION

In accordance with the preferred embodiments, the present invention provides a structure for use in such solid oxide electrolytic devices as solid oxide fuel cells (SOFC's) and solid-state oxygen generator systems (OGS'). Some of the novel aspects of the disclosed structure are provided by the ability to utilize various Cr-containing alloys in the relevant devices, without degradation of the device performance due to unwanted reactions or diffusion processes occurring between the alloy and the remaining device structure. More particularly, it has been discovered that the dual diffusion barrier approach, as disclosed in earlier U.S. patent application Ser. No. 09/968,418, by the present applicant, can prove particularly advantageous when implemented using the particular material structure disclosed herein.

The present invention provides an interconnect structure for use in solid oxide electrolytic devices, which interconnect may be used to join chrome-containing components to adjacent structures of the device, and more particularly, as an electrically conductive interconnect between chrome-containing components and adjacent electrode or electrolyte structures. The structure disclosed separates and seals the various chrome-containing components of the device from oxidizing environments present within such devices, and, in so doing, prevents device degradation. While the failure mechanisms that degrade performance in these high-temperature devices can be complex and interdependent, the disclosed interconnect structure is found to prevent, for example, Cr and oxygen from uniting to form a high-resistivity, Cr₂O₃ layer, as well as to prevent the undesirable diffusion of Cr—due to either gaseous or solid state diffusion—to other surfaces and interfaces within the device. The invention further provides a novel solid oxide electrolytic device structure that may be utilized for either solid oxide fuel cells (SOFC's) or solid state oxygen generators (OGS'). This novel device structure utilizes the diffusion-barrier properties of the disclosed interconnect to implement a solid metal support structure for electrolytic membranes in these same devices.

The present invention overcomes the problems encountered in the prior art through the use of a thin film, complementary dual-layer, high-temperature sealing structure. The dual-layer structure disclosed utilizes at least two different material layers. A first layer comprises a Cr-containing conductive oxide (CCCO) that is, in the first preferred embodiment, formed through the reaction of a vapor-deposited, multicomponent oxide of the group consisting of, but not limited to, various manganites, manganates, cobaltites, chromites, molybdenates, lanthanites, and other oxides that, when deposited as a thin film (<10 micrometers), can form an electrically conductive Cr-containing oxide phase that is stable with respect to an underlying Cr-containing alloy support structure at device operation temperatures (600-800° C.). The first CCCO layer is preferably formed through the reaction of a dense oxide film with an underlying alloy substrate. For the most rugged device operating characteristics, the Cr-alloy structure is of a composition that provides a good thermal expansion match to the solid oxide electrolyte used in the device, such as the materials previously discussed in the background of the invention. However, the dual-layer diffusion barrier disclosed is also found to be effective on much more economical Cr-containing alloys, such as many of the commercially available martensitic and ferritic steels. Also, due to novel aspects of the disclosed device structure, such relatively economical alloys, with less well-matched coefficients of thermal expansion (C.T.E.'s), may be implemented as the bulk components of the electrolytic device.

The CCCO layer is operational in the presently disclosed interconnect structure because it is subsequently coated with a second layer of protective material that provides no effective chemical potential for causing the diffusion of Cr out of the CCCO. The second layer is deposited onto the first layer so as to separate and protect the first layer from the degrading effects of exposure to the gaseous/galvanic environment of the electrolytic device. Platinum metal is found to provide such protective characteristics in the present invention, with an economically viable thickness (<0.5 micrometers). Whereas Cr—Pt intermetallics will normally form quite easily at the high temperatures used in solid oxide electrolytic devices, the Cr bonding in the CCCO is sufficient to prevent such an intermetallic from forming, except perhaps at the immediate CCCO/Pt interface. The second layer is also composed of a second material that does not allow potentially degrading gases from contacting or diffusing to the CCCO, thereby comprising a gas diffusion barrier (GDB). The GDB layer also prevents the occurrence of a three-phase boundary between metal electrode, the CCCO layer, and the gas environment of the electrolytic device interior. The prevention of such a three-phase boundary is found to further prevent activation of undesirable diffusion processes.

The second, GDB, layer is also of relatively high electrical conductivity, so that overall resistance of the device is lowered. When proper deposition methods and materials are utilized to produce high-integrity sealing layers, the invention allows for use of electrically conductive Cr-containing materials that would degrade under normal operating conditions for the relevant devices. For example, such defective oxide, electrically conductive materials as those typically used in the first layer will typically possess more than one possible valency in oxygen bonding, wherein unwanted diffusion of various components of the defective oxide may be activated by the galvanic environment of the device. In the invention's preferred embodiment, the interconnect structure of the present invention may be scaled to a relatively thin (e.g., 2,000 angstroms) aspect, utilizing a minimum of materials, while still providing useful (10⁵ hours) device lifetimes and stable, reproducible performance. Such scales easily allow fabrication of the resulting electrolytic device withing precision tolerances.

It is discovered in the present invention that the methods and thick film structures of the prior art utilizing these conductive oxides were not effective diffusion barriers for the desired application and give unsatisfactory device lifetimes and performance. Surprisingly, however, it has been found, in the present invention, that thin films of thicknesses 100× thinner than those previously used actually provide a more effective diffusion barrier compared to those prior art thick films, when such thin films are incorporated into the dual layer, complementary interconnect structure disclosed herein, and deposited—rather than by non-vapor-deposition methods such as plasma spray, thermal spray coating and spray pyrolisis—by true vacuum vapor deposition methods. The use of vapor deposition techniques is preferred to achieve sufficiently dense films. When the electrically conductive Cr-containing oxide phase is formed as thin film, which is of thickness less than 10 um, and is subsequently coated with a thin film—again, less than 10 um—of a suitable GDB material, the resulting structure may then be subjected to prolonged use as an interconnect in the solid oxide device.

Subsequently, the disclosed dual diffusion barrier is used in a novel solid oxide electrolytic device design that may serve in either a fuel cell or a gas separation device. Rather than using nickel or various porous substrates, the diffusion barrier allows for an electrode support structure to be composed of a Cr alloy component covered with the disclosed thin film interconnect structure. As a result, instead of porous ceramics, bulk, industrially available alloys may be used as either a cathodic or anodic support structure in the device. The resulting metallic support structure of the preferred embodiments is in a sheet form that is patterned with a plurality of small through-holes, which holes provide access to a deposited thin or thick film of the solid oxide electrolyte, the latter which spans and seals one side of the planar support structure. The perforated support structure then provides a first electrode of the device. The opposite side of the solid oxide electrolyte film is then patterned with a second electrode, which is deposited so as to provide a second, counter-electrode structure with a through-hole pattern similar to that of the first electrode. Optionally, a porous conducting over layer may then be deposited over either first or second electrode grids to provide additional three-phase boundaries in the electrode/electrolyte/gas system, to provide various reforming functions, or to provide other functionality relevant to device operation. In one preferred embodiment, the porous material is vapor deposited platinum black, though it may be any of the non-bulk porous electrode materials used in the prior art.

As a result of small through-hole size and stress relieving structures incorporated in the thin film electrolyte, macroscopic strain and stress is substantially avoided in the disclosed device, so that thermal expansion coefficients do not need to be as precisely matched as is required in the case of more macroscopic electrolytic membranes. The ability to use materials of less well-matched C.T.E. is also due to the higher stresses sustainable by vapor deposited thin/thick film structures of the present invention, as opposed to bulk ceramic structures or films created from sprayed nanocrystalline particles. The resulting electrode/electrolyte assembly, which exists on and incorporates the electrode support structure, may then be easily integrated into a variety of SOFC or OGS geometries. Because all bulk components of the disclosed device structure are coated with the disclosed interconnect structure, the disclosed device requires only relatively trivial high temperature seals between the similar alloys that comprise its bulk components.

The thin film solid oxide membrane is disclosed in the first preferred embodiments as yttria-stabilized zirconia (YSZ). However, the solid oxide electrolyte may comprise any of the solid electrolytes used in the art. In addition, a novel thin film electrolyte structure is disclosed which is a stabilized cubic ceria structure that is terminated at its interface with 10-100 nm of YSZ. The resulting thin film electrolyte provides increased chemical stability over prior ceria electrolytes, while not significantly reducing oxygen diffusion rates.

Accordingly, it is an object of the present invention to provide an interconnect structure which is suitable for the high temperature environment of solid oxide fuel cells and electrolyzers.

Another object of the present invention is to provide an interconnect structure for use with solid oxide electrolytes which enables stable, long-term operation of such devices under normal operating conditions.

Yet another object of the present invention is to allow the use of chrome-containing alloys in solid oxide electrolyte devices, while preventing oxidation of the chrome during operation.

Another object of the present invention is to provide a means for preventing diffusion of chrome and other active metal from metallic components of solid oxide electrolytic devices

Another objective of the present invention is to provide a means for using roll-milled stainless steel alloys to comprise all bulk components of a solid oxide electrolytic device.

Still another objective of the present invention is to provide an economical and compact sealing solution for solid oxide electrolytic devices.

Still another objective of the present invention is to provide an economical and compact electrical interconnect for solid oxide electrolyte devices.

Yet another object of the present invention is to provide a monolithic solid oxide-based electrolytic assembly with a thermo-mechanically robust structure for fast heat cycling.

Another object of the invention is to provide a novel fuel cell design that utilizes only bulk, machineable metal alloys as support structures.

Another object of the present invention is to provide an oxygen generator that utilizes only bulk, machineable metal alloys as support structures.

Another object of the present invention is to provide a thin film solid oxide fuel cell structure which does not utilize porous bulk ceramics, or nickel, as a support structure.

Another object of the present invention is to provide a method for forming solid oxide electrolytic assemblies by roll-to-roll processing.

Another object of the present invention is to provide mechanically flexible solid oxide electrolytic assemblies.

Another object of the present invention is to provide a thin film solid oxide electrolytic device that provides flexibility through use of non-planar thin film electrolytes.

Other objects, advantages and novel features of the invention will become apparent from the following description thereof.

### BRIEF DESCRIPTION OF THE DRAWINGS

FIG. 1 is a cross-section of the dual-diffusion-barrier of present invention as incorporated within a typical solid oxide electrolytic device.

FIG. 2 is a cross-section of the dual-diffusion-barrier in an alternative embodiment of the present invention.

FIG. 3 is a perspective view of the disclosed electrode support structure, showing the sealing and active regions.

FIG. 4 is a magnified perspective view of the electrode support structure.

FIG. 5 is a magnified perspective view of the section of FIG. 4, with its through-hole pattern filled with planarized sacrificial material.

FIG. 6 is a magnified cross-section of a portion of the active region in the disclosed solid oxide electrode/electrolyte assembly, taken along dashed line ‘a’ in FIG. 4.

FIG. 7 is a magnified cross-section of a portion of the active region in the disclosed solid oxide electrode/electrolyte assembly, showing an alternative electrolyte structure.

FIG. 8a-d is a through-hole structure in different stages of a process flow wherein a polymer sacrificial material is disposed on the first side with an over-wet.

FIG. 9a-b are magnified closed-captions of FIG. 8a and FIG. 8b, respectively.

FIG. 10a-b magnified closed-captions of FIG. 8c and FIG. 8d, respectively.

FIG. 11 is a cut-out top plan view of an over-wet cell in accordance with the preferred embodiments of FIGS. 8-10.

FIG. 12 is a cross-sectional view wherein various geometric dimensions of the planar support structure are indicated.

FIG. 13(a-b) is a perspective view and cut-away of a through-hole structure of the present invention.

FIG. 14(a-d) is a through-hole structure in different stages of an alternative process flow wherein a polymer sacrificial material is disposed on the first side.

FIG. 15(a-h) are various embodiments of patterned electrode structures deposited on free-standing electrolytes that are formed in the through-holes.

FIG. 16(a-b) are a top planar view and perspective view, respectively, of a patterned alloy sheet for providing various planar elements of the disclosed electrolytic device.

FIG. 17 is a schematic of a roll-to-roll vacuum chamber for web-coating layers of the present invention, wherein a preferred layout of vapor sources and deposition stages is provided.

FIG. 18 is a preferred process flow for fabrication of the planar support structure (17) and interconnect/manifold elements.

FIG. 19 is a preferred embodiment of the invention comprising etched sheet-metal manifolds.

FIG. 20 is a preferred embodiment of the inventive electrolytic device utilizing chemically etched thin metal sheet for all structural components of the device, wherein dendritic gas channels are etched in bipolar interconnection elements.

FIG. 21(a-d) are perspective views of the disclosed concave electrolytic film, embodied as various wrinkled, creviced, or modulated shapes providing combinations of concave and convex surfaces.

FIG. 22(a-d) are alternative preferred embodiments of the electrolytic film and support structure.

### DESCRIPTION OF THE PREFERRED EMBODIMENTS

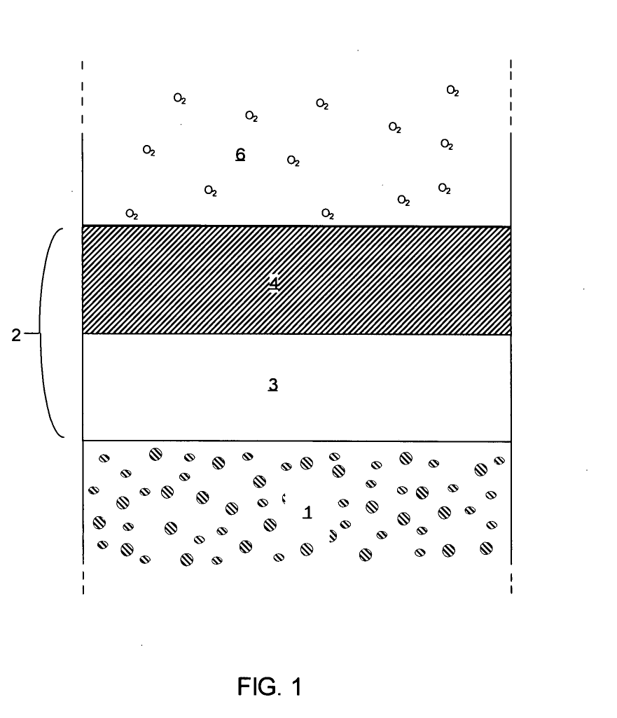

The following description and FIG. 1-22 of the drawings depict various embodiments of the present invention. The embodiments set forth herein are provided to convey the scope of the invention to those skilled in the art. While the invention will be described in conjunction with the preferred embodiments, various alternative embodiments to the structures and methods illustrated herein may be employed without departing from the principles of the invention described herein. Like numerals are used for like and corresponding parts in the various drawings.

FIG. 1 is a preferred embodiment of the present invention, wherein a chrome-containing metallic alloy structure (1) in a solid oxide electrolytic device is coated with the disclosed dual-layer interconnect structure (2). The component may be a bipolar connector plate used in solid oxide fuel cells and oxygen generators, or the supporting electrode disclosed in later figures. It may be noted from the preferred embodiments of FIG. 1 that a first CCCO layer (3) separates a second GDB layer (4) from the underlying chrome alloy structure (1). The CCCO layer may comprise various Cr-containing, electrically conducting manganites, manganates, cobaltites, chromites, molybdenates, or lanthanites. In the first preferred embodiment, the CCCO layer is composed of a LaSrCrMnO polycrystalline phase, and the GDB layer is platinum, though it may also comprise Ni metal or alloy in some applications. Without such a CCCO layer, at typical device operating temperatures, the Cr atoms will diffuse into the Pt to form such intermetallics as Cr₃Pt and CrPt, which will subsequently result in an electrically insulating layer forming at the Pt surface, and eventual sublimation of Cr from the surface. The CCCO layer, however, provides sufficient binding energy to the Cr atoms, so that diffusion of Cr into the Pt is no longer chemically activated at device operating temperatures. At the same time, the Pt protects the CCCO layer from being degraded due to undesirable interfacial effects that would otherwise occur between the CCCO surface and the gaseous environment inside the device. These unwanted interfacial effects can include galvanic effects that activate reduction or otherwise effect the Cr—O bonding at the CCCO surface so that Cr sublimes or diffuses from the surface. Furthermore, when the gas media (6) of the device contains oxygen, the GDB layer prevents diffusion of oxygen from the gas media to the CCCO/alloy interface to form a low conductivity Cr₂O₃ layer.

In the first preferred embodiment the CCCO layer is most easily formed by first depositing 100-10,000 nanometers of an electrically conducting manganate, such as (LaₓSr₁₋ₓ)MnO (LSM), on the surface of the Cr alloy component by such energetic deposition means as sputtering. Subsequently, the component is rapidly annealed with a first anneal to form an intermediate phase between the LSM coating and the Cr in the underlying alloy, thus producing a LaSrCrMnO (LSCM) CCCO layer. It is sufficient to perform the first anneal in air, with a fast ramp (typically less than 15 minutes) to 950° C., where the component is held for about fifteen minutes, depending on the composition and thickness, before cooling back down to room temperature in about fifteen minutes. This fast anneal allows for the LSCM CCCO layer to form without substantial formation of a Cr₂O₃ layer at the alloy-LSCM interface. Subsequently, the Pt GDB layer is deposited onto the LSCM layer, after which the resulting component is subjected to a second anneal similar to the first anneal. The second anneal is preferred to equilibrate the resulting heterostructure before subsequent processing, as well as to promote adhesion within the thin film stack. In the first preferred embodiment, both CCCO layer and Pt layer are less than one micrometer in thickness, with the Pt layer found most effective at thicknesses between 0.1 and 0.5 micrometers.

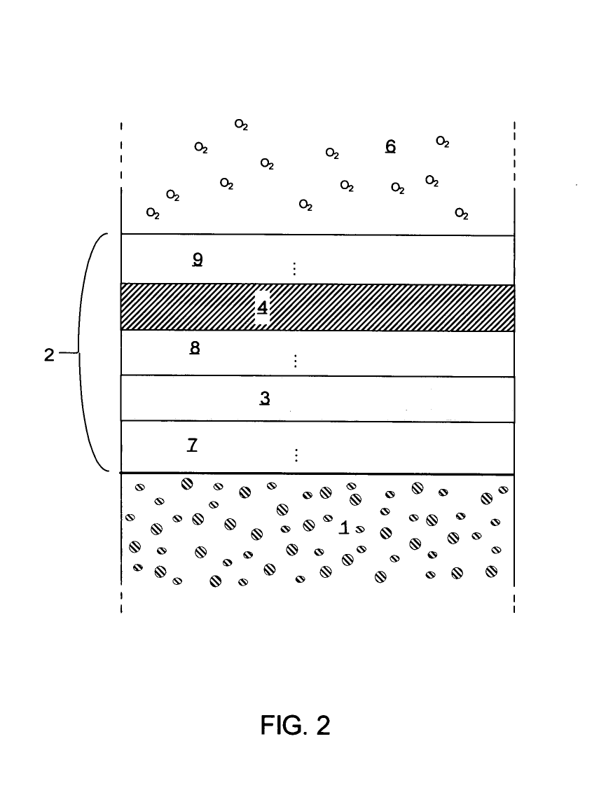

In the preferred embodiment, dense and stoichiometric materials for the dual-layer interconnect structure (2) of FIG. 1 are achieved through the use of energetic deposition techniques, such as plasma sputtering, pulsed laser deposition, cathodic arc deposition, or ion-assisted sputter deposition. While these methods may be used to deposit either thin films (≦10 microns) or thick films (≧10 microns), one of the objectives of the present invention is to allow unusually thin, substantially non-porous, layers to provide the desired interconnect integrity. It is found in the present invention that thin films, and less than one micrometer thin films in particular, of the CCCO and GDB layers are actually preferred to avoid fracture and thus, accelerated failure from occurring in the intended device. The material interfaces in FIGS. 1-2 are abrupt in the preferred embodiment, but may also be diffuse to suit the particular device and economics at hand.

An alternative embodiment of the present invention provides for additional layers to be included in the dual-layer interconnect structure (2) for added functionality. FIG. 2 is a cross-section of an alternative structure that has the dual-layer CCCO/GDB diffusion barrier imbedded within it, and operates in accordance with the principles already described. In this alternative embodiment, a first interfacial region (7) exists between the chrome alloy structure (1) and CCCO layer (3); a second interfacial region (8) exists between the CCCO layer (3) and GDB layer (4); and, a third interfacial region (9) exists between the GDB layer (4) and the gaseous media (6) that exists within the solid-oxide electrolytic device. In the embodiments of FIGS. 1-2, the gaseous media (6) is an oxygen-rich gas that may exist in an OGS or an SOFC. One or more of these interfacial regions may be occupied by additional layers that may be either a repetition of the CCCO/GDB scheme disclosed, or supplementary layers for providing additional functionality. The additional functionality of these supplemental layers may include adhesion-promoting layers, strain-compensating layers, additional diffusion barriers, catalytic layers, thermal barriers, and so forth. These additional layers may also include such lanthanites, chromites, cobaltites, ruthenites, manganites, and other such conductive oxides that have been discussed in the prior art. In any case, the benefits of the present invention are acquired through incorporation of the required sequence of materials and sealing layers (Cr-containing alloy, thin film CCCO layer, and thin film GDB layer). In the alternative embodiments of FIG. 2, in which additional material layers may be deposited to form the first interfacial region (7), it is likely that the desired final composition of the CCCO layer should be obtained in the vapor deposition process itself, since obtaining Cr diffusion from the alloy may be impeded by any additional material layers of the first interfacial region (7).

It is to be understood that the precise materials utilized are but a preferred embodiment of the invention. For example, other electrically conducting, Cr-containing oxides other than LaSrCrMnO may also be found to serve the role of the CCCO layer in the present invention. In some cases, the GDB layer may also be composed of metallic layers other than Pt. Similar performance may also be obtained through the use of metallic compositions including Pt, Au, Ni, Mo, and Nb. However, in the case of single-element metals, Pt is preferred, in the present disclosure, to provide the required degree of both adhesion and oxygen resistance.

It is also to be understood that the compositions suggested are nominal, as small compositional variations due to doping or contamination would typically not compromise the operation of the invention. It is also to be understood that, while diffusion of chrome and oxygen have been found, in the present invention, to be the dominant mechanism of failure in the devices discussed, the disclosed sealing structure of FIGS. 1-2 is also effective against a myriad of other failure mechanisms, including stress/strain-related failure, galvanic corrosion, and failure due to diffusion of less active constituents present in such devices, e.g., Fe, Ni, etc. As such, the terms “chrome-containing conducting oxide” and “gas diffusion barrier” are used to positively identify components of the disclosed structure in accordance with their best understood functions.

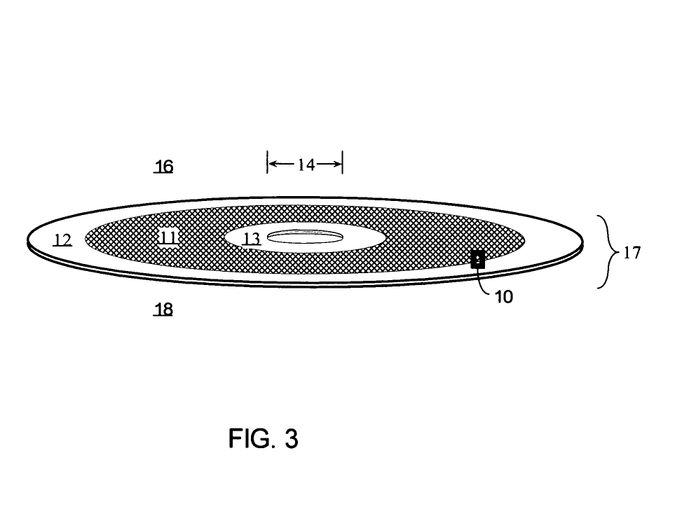

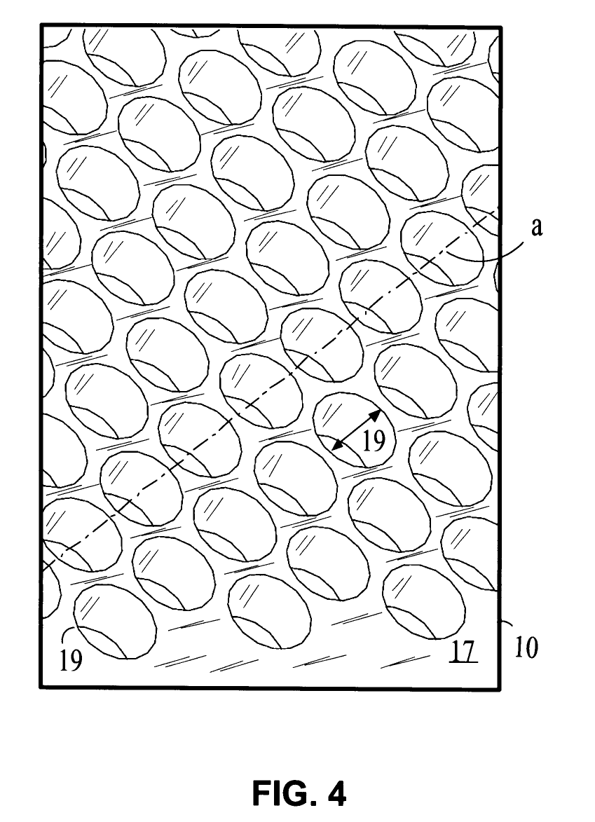

The underlying Cr alloy in FIGS. 1-2 can be fashioned for providing a variety of structural elements in a variety of device designs, including housing structures, electrode structures, interconnect structures, etc. In the preferred embodiments, the underlying alloy is fashioned as either an anodic or cathodic electrode support structure, which, after the application of the dual diffusion barrier of FIGS. 1-2, will provide reliable performance in the high-temperature (typically 600-800° C.) environment of solid oxide electrolytic devices, such as a SOFC or OGS device. In particular, the electrode support structure (17), in FIG. 3, provides the bulk substrate material and shape for producing a resultant solid-oxide electrode/electrolyte assembly. Initially, the electrode support structure of FIG. 3 is fashioned as a thin planar element, which has an active region (11) that provides a plurality of densely spaced through-holes that allow communication between the first side (16) and the second side (18) of the planar element, so that the active region of the support structure is perforated. A magnified perspective of the electrode support structure is shown in the captioned view of FIG. 4, which corresponds to the outlined box (10) in FIG. 3. The remaining planar regions of the electrode support structure comprise inner mating surfaces (13) and outer mating surfaces (12), which exist on either side of the structure, and provide a sealing surface to the gas manifold components of the electrolytic device.

The electrode support structure (17) of FIG. 3-4, may be fashioned from one of the commonly available Cr-containing alloys discussed earlier, such as Hastalloy™ stock, but is preferably fashioned from one of the bulk alloys developed for close thermal expansion match to YSZ, such as Met-X or Pansee alloys. The bulk alloy forming the electrode support structure (17) is coated and processed so as to have the disclosed dual-layer diffusion barrier covering all its surfaces. Conformal coating of the initial alloy planar element may be readily achieved with standard physical vapor deposition techniques, since the aspect ratio of the through-holes (19), in FIG. 4, is, preferably, sufficiently close to unity, so that directional coating processes will provide the required conformal coating.

After application of the disclosed diffusion barrier, using the preferred platinum termination layer, the electrode support structure of FIG. 3-4 can then be repeatedly cycled as either a cathodic or anodic support structure in a variety of oxidizing/corrosive environments without degradation. The electrode support structure is further processed and coated to provide the remaining solid oxide electrolyte and electrode structures of the resulting solid oxide electrode/electrolyte assembly.

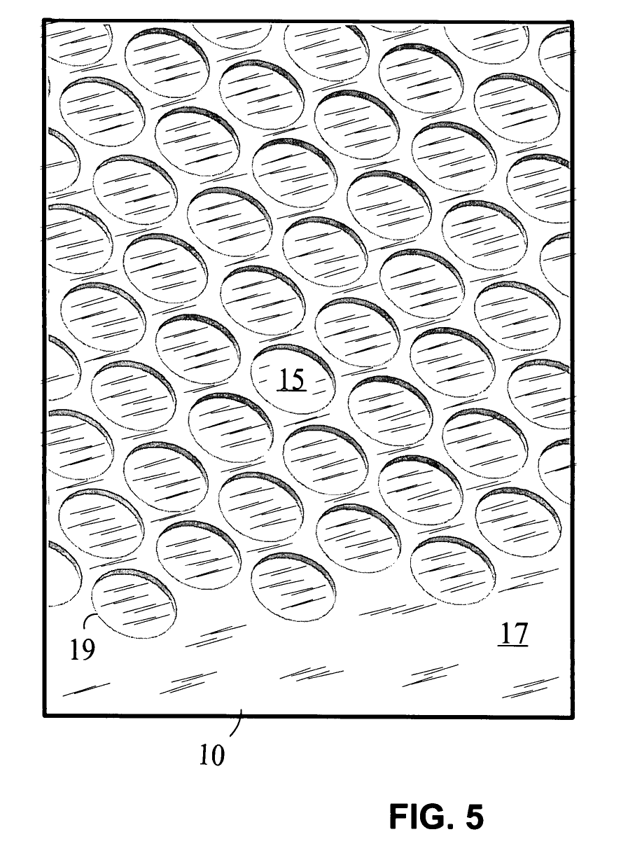

In accordance with the first preferred embodiments, once the platinum-terminated structure of FIGS. 3-4 is produced, additional building up of thin film device structures may proceed in a variety of processes common to microelectronics industry. In the preferred embodiments, the structure of FIG. 4 is subsequently loaded with a sacrificial material (15), so that the through-holes (9) are filled with the sacrificial material, in FIG. 5. High-solids organic resins are found to adequately provide the desired attributes of the sacrificial material, in that they can be readily planarized to the material surface corresponding to the first side (16) of the electrode support structure (17), while providing a sufficiently smooth interface between the sacrificial material and the support structure (17). Such organic resins provide a suitable surface for subsequent deposition of the solid oxide electrolyte, and are easily removed by baking out the support structure after deposition of the electrolyte.

Alternatively, the sacrificial material used may be any of the wide variety of suitable sacrificial materials used in the manufacture of similarly scaled devices, such as those used in microelectronics packaging, MEMS fabrication, or sensor design. Accordingly, the sacrificial material may be one of a variety of resins, epoxies, or easily etched glasses or metals. The sacrificial material may be sufficiently planarized by a release mold, controlled wetting, or by lapping, but in any case, results in the surface of the first side of the electrode support structure becoming a continuous surface, as represented in FIG. 5.

The choice of sacrificial material will depend upon the solid oxide electrolyte to be subsequently deposited, and the chosen procedure by which the desired solid oxide phase (e.g., cubic zirconia) is attained. In the case that the electrode support structure and impregnated sacrificial material are to be maintained at a high temperature (>300° C.) during vapor deposition of the solid oxide electrolyte film, then the choice of sacrificial materials becomes restricted, since sacrificial organic compounds will degrade, and many sacrificial metals, such as Cu and Sb, begin to diffuse into the platinum GDB layer of the preferred support structure (17). For deposition temperatures below T_{g}, certain low temperature glasses that possess a C.T.E. well-matched to that of the electrolyte may be used. For example, in the case of YSZ, Schott glass FK5, with T_{g} of 466° C., provides such properties, and is easily removed by buffered hydrofluoric solutions.

A solid oxide electrolyte and electrode structure are fabricated in the active region (11) of the electrode support structure, and are obtained through the deposition and patterning of thin- and/or thick-film device materials. These device materials include the solid oxide electrolyte as well as a material for a second electrode structure that acts as a counter-electrode to the support structure. These device materials are deposited onto the active region (11) of the electrode support structure (17), which device materials may be deposited from either the first side (16) or the second side (18) of the planar support structure.

In the preferred embodiments, the solid oxide electrolytic material may be deposited at relatively low temperatures, and, after removal of the sacrificial material, annealed at high temperatures to achieve the desired phase. For example, YSZ can be deposited in a nanocrystalline (cubic), slightly compressively stressed, form at room temperature, using on-axis, unbalanced “Type II” magnetrons of the magnetron sputtering art. These nanocrystalline films may then be transformed into more fully crystallized (by x-ray diffraction analysis) cubic zirconia films by way of annealing these films at 800° C. in wet oxygen. Such temperatures are, as already discussed, easily accommodated by the disclosed supporting electrode structure. The electrolytic oxide should typically be deposited so as to be stress-free or somewhat compressively stressed, so that the electrolytic oxide film will remain after removal of the sacrificial material and will withstand device temperatures with alloy support structures composed of slightly larger C.T.E (coefficient of thermal expansion) than that of the electrolyte.

Alternatively, deposition of the solid oxide electrolyte (20) may be performed at elevated substrate temperatures, so that a larger-grained polycrystalline phase may be acquired as-deposited. Such elevated temperatures typically require that the sacrificial material be inorganic.

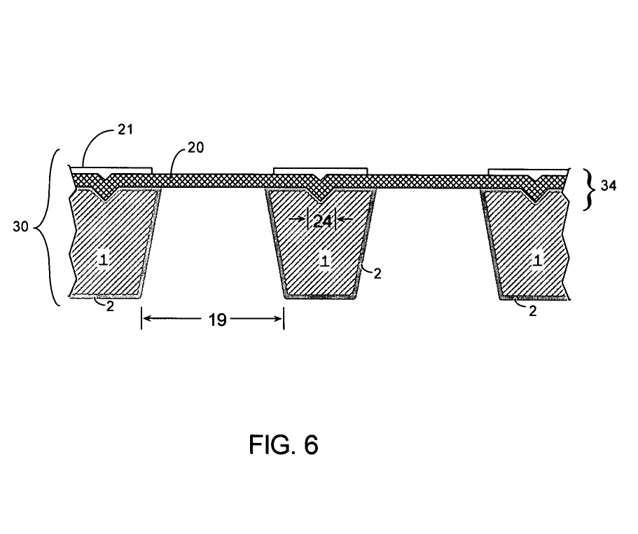

The solid oxide electrolyte material is deposited on this first side of the planarized support structure (17), with holes filled by sacrificial material, so that the electrolyte is deposited as a substantially sheer film that seals the first side (16) of the support structure on which it is deposited. In this way, the solid oxide electrolyte (20), which hermetically and electrically separates the electrode support structure from a subsequently deposited counter-electrode structure, is formed. In the first preferred embodiments, this solid oxide electrolyte is deposited for a resulting electrolyte thickness corresponding to a thin film (<10 um). The sacrificial material (15) may then be etched away to provide a resulting structure that allows access to either side of the solid oxide electrolyte film (20), in FIG. 6. With reference to the electrode support structure (17) of FIG. 3, the solid oxide electrolyte (20) is deposited over all regions of the first side of the electrode support structure, so that the outer mating surface (12), the inner mating surface (13), and the active region (11) on the first side (16) of the electrode support structure are all covered with the electronically insulating electrolyte (20). The solid oxide electrolyte layer (20) thereby allows for the subsequent metallic manifolds that contact the mating surfaces of the first side to be electronically insulated from the underlying electrode support structure.

While various materials have been found to provide desirable oxygen diffusivity, the solid oxide electrolyte of an alternative embodiment is a multilayer film that is formed by depositing yttria stabilized zirconia (YSZ) as the first and last layer of the resulting solid oxide electrolyte film. In this way, the stability of YSZ is obtained at the interface of the electrolyte/gas/electrode boundary, where less stable electrolytes, such as stabilized CeO₂, are found to reduce and deteriorate. In the preferred embodiment, YSZ is first sputter deposited in a multi-magnetron chamber possessing both a YSZ source and a CeO₂ source. The first 100 nm of the electrolyte is deposited as YSZ, at which point, the CeO₂ is deposited to provide the majority of the electrolyte thickness, which is typically 1-10 micrometers. The electrolyte deposition process then switches back to YSZ to terminate the electrolyte layer (20) with about 100 nm of YSZ. However, the electrolyte may be fabricated using different solid oxide electrolytes, laminated structures, or solid solutions of one or more solid oxide electrolytes.

The electrode-supported electrode/electrolyte assembly (30) of the preferred embodiments, in FIG. 6, includes the electrode support structure (17), which includes the bulk alloy structure (1) and dual-layer interconnect structure (2). The electrode/electrolyte assembly (30) utilizes the electrode support structure to support a subsequently formed, thin/thick film, electrode/electrolyte structure (34) in the perforated active region (11) of the electrode support structure. This thin/thick film structure includes the solid oxide electrolyte (20) and a counter-electrode structure (21).

It may be noted that the electrode support structure, in FIG. 6, has surface relief features (24) between the through-holes (19), which place a discontinuity in the subsequently deposited solid oxide electrolyte film (20). While such relief features may comprise a variety of aspects, their main purpose is to provide discontinuities in the planarity of the thin-film solid oxide electrolyte, thereby providing means for relieving internal stresses that may accumulate in the electrolyte due to any mismatch between the C.T.E. of the electrolyte and that of the underlying alloy structure. Accordingly, such discontinuities may be preselected or randomly produced by grinding the original alloy structure (1) for a roughened texture. In some cases, it may be preferable to pattern the solid oxide film so as to provide discontinuities yielding similar surface relief structures. In any case, the surface relief provides a means for preventing internal stress in the solid oxide film from accumulating over any appreciable distance. As such, the surface relief should preferably be of the order or greater than the thickness of the solid oxide film. Accordingly, the electrolyte (20) of FIG. 6, possesses surface relief features (24) that are greater than 1/10 the thickness of the electrolyte; and, in FIG. 6, the deviation from planarity is roughly ½ the thickness of the solid oxide electrolyte (20). Accordingly, if the surface relief features are to be provided by grinding or bead-blasting the alloy structure, the surface roughness should be greater than 1/10 of the electrolyte thickness. In the case, as in the preferred embodiments, that the electrolyte is formed with a sacrificial material in the through holes, the sacrificial material may then also be planarized with similar relief structures. As a result, the subsequently deposited electrolyte film, in FIG. 6, can possess the discussed surface relief structure over the through-hole region as well as in the area of contact with the electrode support structure (17). Such surface relief not only aids in the relief of mechanical stress, but also increases electrolyte surface area for increased device output. Such surface relief in the electrolyte film also provides a rough surface that enables discontinuous growth of porous electrode materials that may be subsequently deposited on the electrolyte.

After the electrolytic oxide film is deposited and the sacrificial material is removed from the through-holes of the electrode support structure, a Pt counter-electrode structure (21) may then be deposited on the side of the electrolytic oxide film opposite to the supporting electrode. This may be deposited by any of the thin/thick film techniques of the prior art, such as sputtering, evaporation, or screen printing. The patterning the counter-electrode structure, in the case that it is the more difficult to etch Pt metal, may be performed by the variety of the dry etching methods developed for Pt electrodes in ferroelectric non-volatile memory industry, though the relatively coarse features of the present electrode structures may be achieved simply through shadow masks.

The alloy structure (1) of the electrode support structure in FIG. 6 preferably comprises a material with C.T.E. sufficiently matched to that of the electrolyte, so that device operation temperatures do not substantially effect strain in the electrode/electrolyte structure (34). Alternatively, such as in the case of a zirconia electrolyte, wherein an alloy of slightly larger C.E.T. than the electrolyte is used—e.g., 316 stainless steel—it is recommended that the solid oxide electrolyte be deposited so as to result in a somewhat convex (or concave) shape in the space of the through-holes (9). This convex shape results preferably from the shape of the underlying sacrificial material during deposition, but may alternatively result from compressive stress. In either of the latter cases, heating of the electrode/electrolyte structure (34) will result in the application of tensile stress on the free-standing electrolytic film that exists over the through-holes, so that the original compressive stress or convex shape will allow for such tensile stress to be applied without film rupture.

It may be noted that, while the electrode support structure comprises an anode in later preferred embodiments disclosed in the present invention, either the electrode support structure (17) or the deposited counter-electrode structure (21) of the electrode/electrolyte assembly may comprise the anode of a resulting device. In either case, the resulting electrode/electrolyte assembly of the preferred embodiments incorporates the following sequence of layers: thin film platinum layer/thin film CCCO layer/bulk alloy/thin film CCCO layer/thin film platinum layer/thin film solid oxide electrolyte layer/thin film platinum layer.

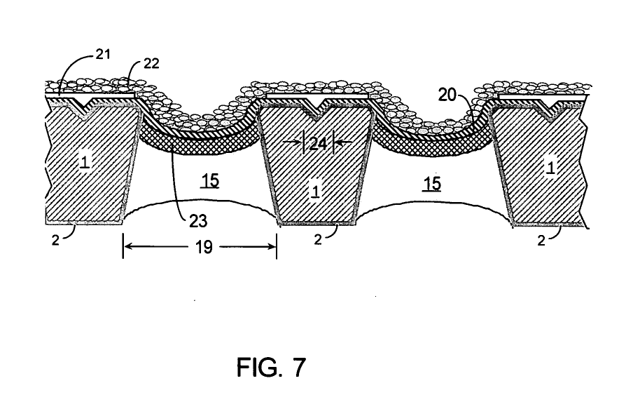

In an alternative embodiment of the invention, the electrode/electrolyte structure need not be substantially planar, as in FIG. 6. In fact, it may be preferred that the electrode/electrolyte structure be formed as a periodic array of convex or concave aspects, as represented in FIG. 7. The wave-like aspect of FIG. 7 is accomplished by the original filling of the sacrificial material, wherein the wetting characteristics of the particular sacrificial material chosen, as well as any surface treatment of the support structure (17), will determine the contact angle of the sacrificial material to the through-holes (19) of the support structure. Accordingly, the resultant solidified sacrificial material (15) may form a recess in the through-hole, as in FIG. 7, so that the thin film electrolyte (20) will possess a resulting concave shape. The electrode/electrolyte structure of FIG. 7 also contains the optional first porous electrode material (22) and second porous electrode material (23) for increasing three-phase boundary interfaces or performing various reforming functions.

Such a non-planar shape, in FIG. 7, provides for additional resistance to stress-induced cracking of the electrolyte, in the case that the support structure possesses a different C.T.E. than that of the electrolyte. Furthermore, the non-planar shape of the electrolyte in FIG. 7 provides for increased surface area, and hence, increased throughput. It should be noted that the thickness of the solid oxide electrolyte (20), in FIGS. 6-7, is normally made quite thin relative the thickness of the electrode support structure. In the preferred embodiments, the solid oxide electrolyte is a film of a thickness corresponding to the thin film range (less than 10 um, or <1×10⁻⁵ meters), whereas the electrode support structure will typically possess a thickness in the range of hundreds of micrometers. While the thickness of the solid oxide electrolyte, counter-electrode, and porous electrode structures, in FIGS. 6-7, are enlarged relative to the scale of the electrode support structure, for purposes of disclosure, it may be noted that the electrode support structure may be made quite thin, so that the resulting electrode/electrolyte assembly (30) would scale proportionally similar to that in FIGS. 6-7.

In device designs incorporating materials possessing well-matched C.T.E.'s, the first porous electrode structure (23) may be used in place of the sacrificial material (15) as a surface on which to deposit the solid oxide electrolyte. In the latter case, the through-holes would first be filled, preferably by screen printing, with a precursor form of the first porous electrode material. Sintering of the precursor/support structure would then result in a permanent porous electrode in place of the sacrificial material (15) in FIG. 7. The thickness of the first porous electrode may be made quite thin, as long as it provides a structural surface on which to deposit the solid oxide electrolyte.

The through-hole structure of the planar support structure, in FIG. 1-22, may possess a variety of cross-sectional profiles. In the first preferred embodiment, the cross-sectional profile of the through-hole provides a tapered, or flared, shape, in that the through-hole profile is not strictly cylindrical, but possesses flared openings at both first surface and second surface of the planar support structure. Accordingly, a region of constricted dimension exists within the hole, between the first and second surfaces, which constricted feature is preferred for wetting by the sacrificial material to form a reproducible and well-defined boundary for the free-standing (convex or concave) electrolytic film that exists over the through-hole features. Such widening of the through-hole structure at the surfaces of the planar support structure may be accomplished by a variety of methods well-known in the art of metal fabrication, including chamfering methods, photochemical milling, electropolishing, etc.

Of course, since the embodied electrolytic film comprises the geometry of a thin layer spanning a through-hole feature, whether the cross-section of a particular free-standing electrolytic film appears substantially convex, or alternatively, concave, will depend upon the orientation of the viewer. Accordingly, in the context of surface shapes formed by thin material layers, convexity and concavity are substantially equivalent qualifications, insofar that such qualifiers distinguish opposing sides of the same material layer.

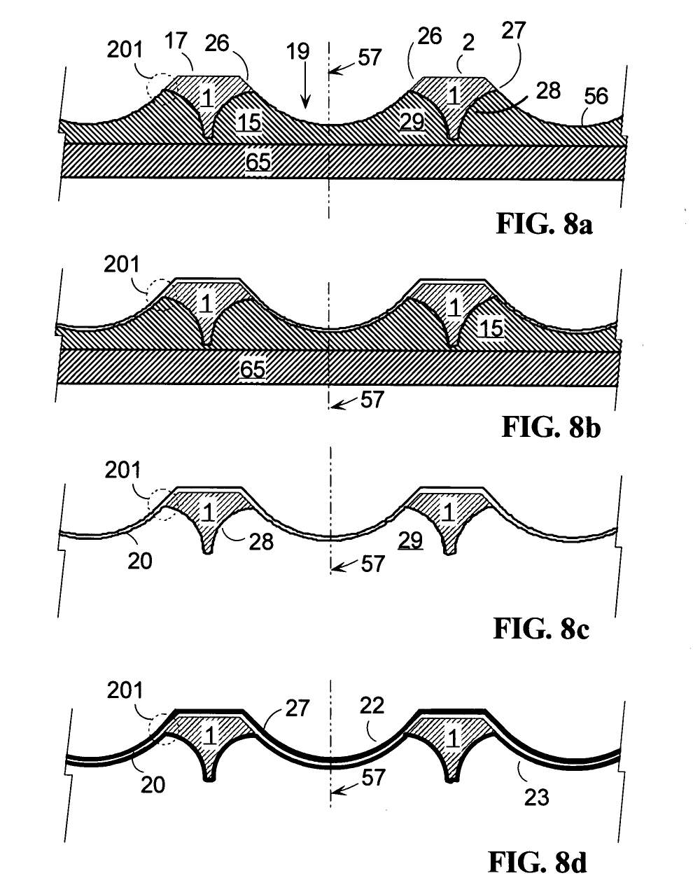

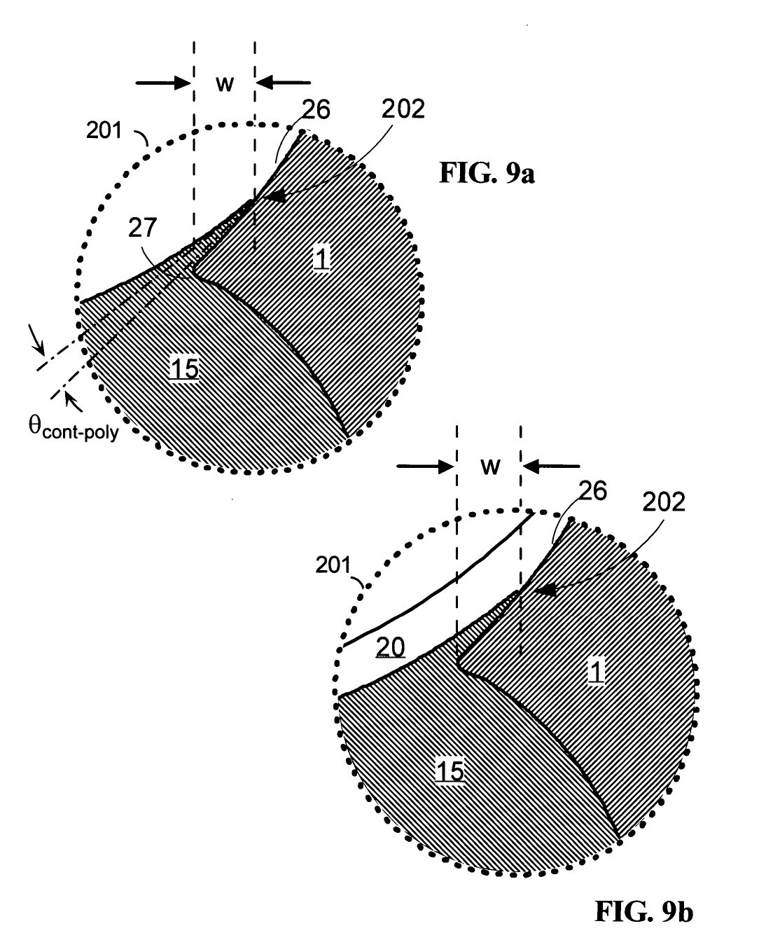

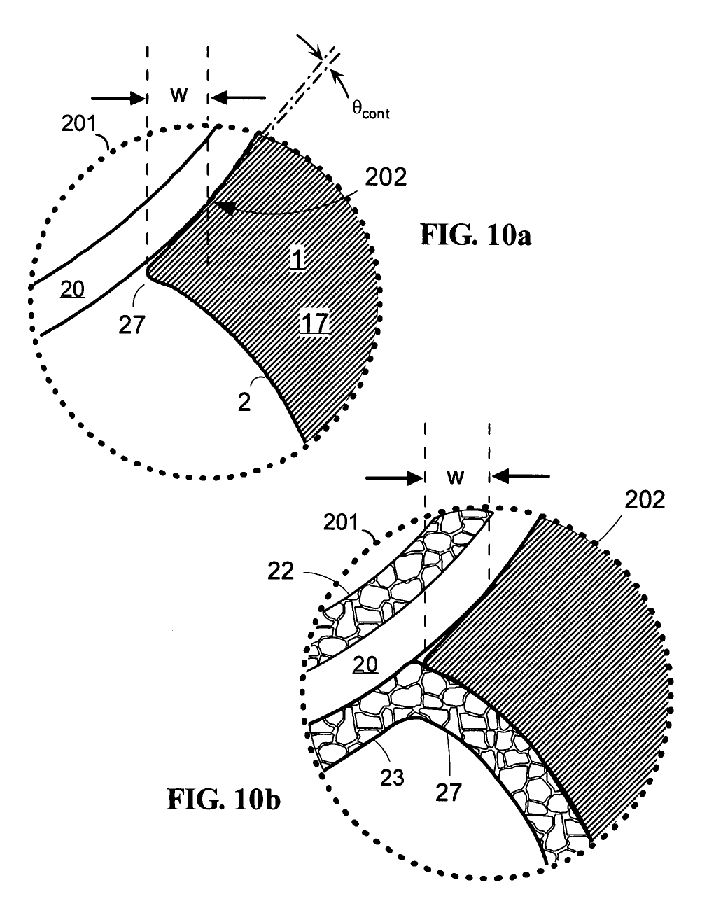

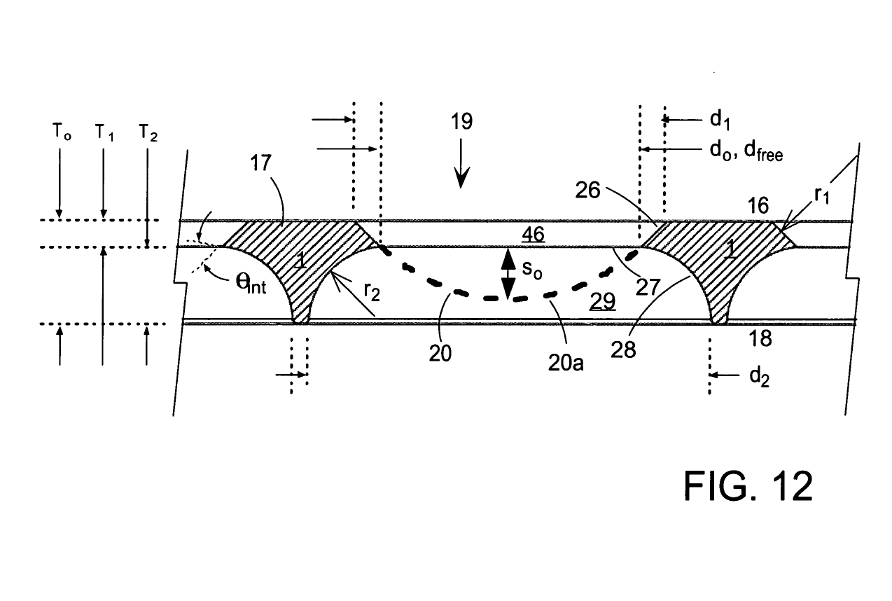

It is found that high-yield manufacturing of the disclosed electrolytic cell structures may be preferably obtained through giving particular attention to the precise structure of the interface between the electrolytic film (20) and the support structure (17). In conjunction with embodiments of FIG. 12, it may be seen that the wetting of a polymeric material to the support structure may be performed to produce a specific concave surface onto which the subsequent electrolytic film is formed, in FIGS. 8-11. Specifically, in FIG. 8a, it is preferred in the present alternative embodiment, that the preferred polymeric wetting material be disposed into the hole structure with sufficient volume to provide a slight “over-wetting” of the constricting surface (27), so that a magnified cross-section (201) of the region of the hole structure corresponding to the smallest diameter (or in the case of a polygonal hole, smallest lateral opening) will reveal that the polymer is actually wet over the region within marginal distance, w, in FIG. 9a. This over-wetting is preferably achieved by pressing the support structure on to a surface, preferably a sheet of flexible material (65) such as foil or mylar, that is supporting a thin and uniform layer (preferably between 5 and 500 microns) of melted polymer, such as a polyethylene homopolymer. Sufficient melted polymer is provided to wet the polymer to the through-hole surface, and slightly over the constriction surface (27) that is formed intermediate between first and second sides of the alloy sheet (1) used in the instant support structure (17). In accordance with the preferred embodiments of FIGS. 8-11, the over-wetting of the through-hole structure provides the result that the sacrificial material, preferably polymeric, is allowed to wet up the through-hole surface enough to overlap the constricting lip (27) by a margin of width “w” that is preferably a distance of greater than 100 nanometers and less than 200 micrometers. More preferably, the distance, w, is such that, 1 micrometer<w<50 micrometers. Such margin of over-wetting results in a resultant displacement of electrolyte contacting position (202) along the through-hole surface, the contacting position being where the subsequently deposited electrolytic film begins a fastened and therefore substantially rigid contact with the surface of the through-hole structure, consistent with the absence of sacrificial material outside of this contacting position or line. After wetting action, the sacrificial material is thus allowed to set into a solidified state, wherein contraction and the formation of a concave surface will occur naturally, and may be further induced or variously altered by appropriately applying vacuum or pressure. In this manner, a very low contact angle is provided between the set polymer and the support structure, θ_{cont-poly}<20°, so that the resultant contact angle between the subsequently deposited electrolytic film to the through-hole interior surface, θ_{cont-elec}, is provided, such that, preferably, 0°≦θ_{cont-elec}<20°, and more preferably, 0°≦θ_{cont-elec}<5°, in FIG. 10a. A contact angle of substantially zero degrees is readily accomplished in this embodiment, since removal of the sacrificial material will typically result in relaxation of the electrolytic film, so that the film will accordingly rest against the surface provided within the margin “w”, and hence θ_{cont-elec}≦θ_{cont-poly}. After formation of the electrolytic film and removal of the sacrificial material, various means may be utilized to readily verify the actual line of formation of the contact or fastening position (202) between the electrolytic film and the support structure, including optical microscopy and scanning electron microscopy. Since the non-contacting region, within the margin, “w”, will typically be greater than a fraction of a visible light wavelength, optical microscopy will typically reveal the non-contacted region in “w” to have different reflective characteristics than the region that is contacted to the support structure.

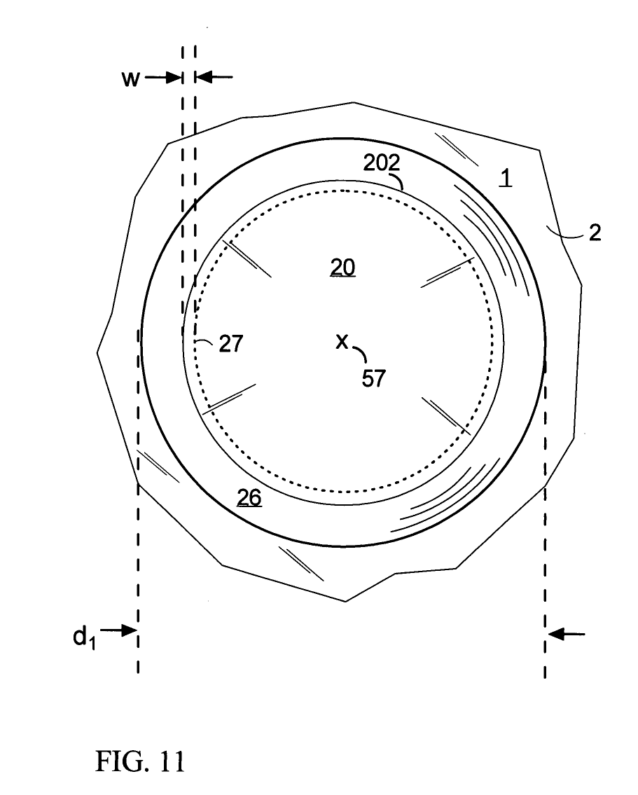

Subsequent to the formation of the electrolytic layer, in FIGS. 8-11, electrode and counter-electrode materials (anode and cathode) are then formed over either side of the electrolytic layer, as before. With a preferred minimized contact angle at, or close to, θ_{cont-elec}=0° degrees, a porous electrode material (22, 23) formed over the first and second side of the support structure will result in a monolithic electrolytic assembly, in FIG. 8d, that possesses enhanced thermo-mechanical shock resistance, due to the resultant contact structure, in FIG. 10b. Outside of the line of contact (202), in FIG. 11, the electrolytic film (20) possesses substantial adhesion to the support structure that is consistent with a vapor-deposition-formed interface of two compatible materials. The margin of width, w, thus separates the region of well-adhering electrolyte film from the region of film having an adjacent layer of porous electrode material (23), in FIG. 10b. The presently embodied structure thus avoids a rigid three-way intersection between the support structure, the electrolytic film, and the porous electrode layer, resulting in the absence of a mechanically constraining geometry that can lead more readily to fracture.

The methods disclosed herein may also benefit the field of micro-concentrator arrays, wherein such methods may be utilized for forming environmentally robust refractive or reflective elements for concentrating light onto adjacent solar panels, particularly for multi-junction devices.

A cross-sectional view of the planar support structure, in FIG. 12, indicates various geometric dimensions of the planar support structure. While it is possible to provide the free-standing portion (indicated by dashed line 20a) of the electrolytic film over a simple cylindrical through-hole profile, it is found relatively problematic to accomplish reliable wetting characteristics for the sacrificial material in such a cylindrical structure. It is instead found highly preferable to provide an enlarged opening of the through-hole features at the second surface of the planar support structure, which is preferably the surface toward which the convex aspect of the free-standing film protrudes. Most preferably, the through-hole feature is widened at both first and second surfaces, relative to the constricted through-hole dimension intermediate to the two surfaces.

In conjunction with the cross-sectional schematic, in FIG. 12, the thickness, T_{electrolyte t}, of the electrolytic film (20) is preferably less than 10 micrometers, such that 100 nm≧T_{electrolyte}≧10.0 um. The thickness, T₀, of the planar support structure (17) is preferably between 0.0001″ and 0.010″, and more preferably between 0.001″ and 0.005″ (inches); though, thickness' outside this range may readily be envisioned.

In accordance with the embodiments of FIGS. 6-22, widened openings of the through-hole feature at first and second surfaces of the planar support structure provide an intersection region between these two widened regions, thus providing a roughly hour-glass-shaped aspect, in that there is defined a relatively constricted aperture at a position intermediate between the first and second surfaces of the device, wherein the free-standing electrolytic film (20a) is preferably attached at the surface of intersection referred to herein as the constriction surface (27), which resides between the two widened regions preferably comprising a smaller flared surface (26) and a greater flared surface (28), and wherein this constriction surface of the through-hole feature substantially defines the outer boundary of the free-standing film.

The widened, or flared, through-hole features are preferably formed with two distinct outer regions comprising a greater through-hole volume (29) defined by the greater flared surface (28), and preferably a smaller through-hole volume (46) defined as volume surrounded by the smaller flared surface (26), so that the intersecting region defined by the intersection of these two flared surfaces preferably comprises the periphery of the free-standing electrolytic film. The greater through-hole volume preferably defines a space between the first surface and the second surface of the planar support structure for containing the convex aspect of the free-standing electrolytic film. In accordance with the first preferred embodiments, the constriction surface comprises a very thin annular region comprising essentially the edge defined by the intersection of the greater flared surface (28) and smaller flared surface (26). Accordingly, such preferred constriction surface (27) comprising an edge is considered to be the surface defining the edge or such surface in immediate vicinity of the edge, relative to other pointed out regions of the through-hole feature described herein.

The free-standing portion (20a) of the electrolytic film is the portion of electrolytic thin film that is left free-standing over the through-hole feature, so that the film may flex in response to temperature changes. Such ability to flex defines the free-standing characteristic of the film, and thin electrode structures that are formed adjacent to the free-standing film preferably do not interfere with such free-standing characteristic.

The thickness, or axial depth, T₁, of the smaller through-hole volume (46) provided within the smaller flared surface (26) of the through-hole feature is preferred for both providing clearance protection of the free-standing film, as well as for providing a surface for controlled wetting by the sacrificial material. While T₁ may be exceedingly small relative to T₀, it is nonetheless of great significance in subsequent processing of the electrode/electrolyte assembly. Accordingly, it is preferred that T₁ be equal or greater than the thickness of the electrolytic film, so that T₁≧T_{electrolyte}.

Also indicated is axial depth, or the thickness, T₂, of the greater through-hole volume (29). In accordance with the preferred embodiments, it is preferable that the depth of the greater through-hole volume (29) possess a substantially greater thickness, T₂, than the thickness, T₁, of the smaller through-hole volume (46). T₁ is preferably substantially smaller than thickness, T₂, of the greater through-hole volume (29) by a ratio of T₁/T₂≦0.5, and preferably, smaller ratios are utilized, so that T₁/T₂≦0.3.

Such preferred difference in the thickness of opposing flared regions allows desirable utilization of the overall thickness, T₀, of the planar support structure, since the greater flared surface (28) defines the size of the greater through-hole volume (29), which volume is where most of the free-standing electrolytic film is preferably disposed.

In accordance with the preferred embodiments, it is also preferable that the through-hole features of the planar support structure also incorporate the smaller flared surface (26), for further enabling reproducible wetting by the sacrificial material. The smaller flared surface (26) is also preferred for protecting the free-standing electrolytic film, since it provides additional clearance between the first surface and the free-standing film, so that preferably the free-standing portion of the electrolytic film is found to reside completely within the planes of the first surface and the second surface. It is accordingly preferred that the smaller through-hole volume (46) has finite thickness, T₁, preferably greater than the thickness, T_{electrolyte}, of the electrolytic film.

Consistent in the present disclosure will be the embodiment of a free-standing electrolytic film, wherein the free-standing film is defined as such by virtue of being created with a free-standing aspect, such that it is fabricated to be self-supporting over the so-described region of the film. Such free-standing status is independent of, and not altered by, whether or not electrically conductive, or other, layers are formed on the free-standing film.

In fact, the free-standing electrolytic film may be formed with electrode layers incorporated in or on the film, whereas, the electrolytic film is still defined herein as free-standing, since it can nonetheless freely strain, or flex, as a stress-relieving structure.

The present embodiments, in FIGS. 12-22 incorporate a convex aspect in the free-standing electrolytic film, so that the free-standing film comprises a stress-relieving structure for relieving stresses that arise between the electrolytic film and the underlying planar support structure as a function of temperature.

The term “dimension”, as applied to dimensions, d₀, d₁, d₂, of the through-hole features will preferably refer to diameters of the preferred circular shape; though, such dimensions may apply equally well to other through-hole shapes, including but not limited to circularly symmetric polygons, including hexagons, octagons, pentagons, as well as to irregular and oblong shaped through-holes.

Preferred relationships between dimensions are pointed out relationships between the coplanar distances pointed out in the cross-sectional planes exemplified in the figures, wherein the cross-sectional planes are taken roughly through the central axes of the through-hole features.

The aperture or clear opening provided by a through-hole feature of the planar support structure is most preferably smallest at a region of the through-hole feature that is intermediate between the planar surfaces of the planar support structure. Accordingly, there will preferably exist in the through-hole feature the intermediate constriction surface (27) having a smallest constricting dimension, d₀.

The intermediate constriction surface (27) is preferably a substantially annular region defined by intersection of the smaller flared surface and the greater flared surface, in FIG. 12, so that the constriction surface accordingly comprises an edge formed by this intersection. In this embodiment, the annular edge formed by this intersection of the smaller flared surface and the greater flared surface, will accordingly provide the constricting dimension, d₀.

This lateral constricting dimension, d₀, is also the preferred diameter of the free-standing electrolytic film, so that the lateral dimension, d_{free}, in FIG. 12, of the free-standing film (20a) is preferably substantially equal to d₀, wherein d₀ and the outer dimension of the free-standing film (20a) are coplanar dimensions in a cross-sectional plane, such as is represented in the cross-sectional plane taken normal to first and second surfaces, in FIG. 12.

The through-hole constricting dimension, d₀, of the through-hole structures, is preferably between 0.0001″ and 0.0200″, and more preferably between 0.0005″ and 0.0100″, though dimensions outside this range may readily be envisioned.

Thus, in the first preferred embodiments, the free-standing electrolytic film, when defined by outer boundary, d₀, intermediate to first and second sides (16, 18) of the planar support structure, is disposed entirely between said first and second surfaces, so that said surfaces may be applied flush to a secondary structure—such as a processing drum, mask, or a planar interconnect structure of the electrolytic device—without undesirable pressure to the free-standing portion of the electrolytic film. Such containment is of great advantage for subsequent handling and roll-to-roll processing

Further defined, in FIG. 12, is the preferably widened through-hole dimension, d₁, of the smaller flared surface (26) at its intersection with the first surface of the planar support structure; and, the widened through-hole dimension, d₂, of greater flared surface (28) at its intersection with the second surface of the planar support structure.

In the preferred embodiments, wherein the through-hole features incorporate flared surfaces, the through-hole dimensions, d₁ and d₂, of the through-hole opening at the first surface and second surface of the planar support structure, respectively, are both preferably greater than d₀. Accordingly, it is preferable that d₀<d₁ such that, 3.0≧d₁/d₀≧1.1; and, preferably, d₀<d₂ such that, 3.0≧d₂/d₁≧1.2.

The flared surfaces of the through-hole features may comprise any of a variety of widened profiles. Such various profiles comprise those of chamfers, bevels, fillets, etc., and will be generally regarded herein as a subset of all flared surfaces that may comprise the side-walls of roughly circular or circularly symmetric through-holes, and wherein a straight, angled chamfer, as represented in FIGS. 6-7, may be seen to be simply a subset of radius-ed fillets having an infinite radius (i.e., a flat profile). A variety of such fillet surfaces are found to be readily formed through the preferred photochemical milling methods. The use of such a fillet surface allows for the constriction surface to provide a relatively small angle of intersection, θᵢₙₜ, so that preferably θᵢₙₜ is less than 120° (degrees), and more preferably less than 90°, wherein this angle represents the angle between the two fillet surfaces at the intersection. This angle is of relatively greater importance in the preferred embodiment that the constriction surface comprises substantially an edge of intersection between the smaller flared surface and the greater flared surface,

In the preferred embodiment that the flared surfaces possesses a cross-sectional profile that is essentially curved, in FIG. 12, in the manner of a fillet, such fillet surfaces have an effective fillet radius, r₁, of the smaller flared surface (26) of the planar support structure, and most preferably, an effective fillet radius, r₂, of the greater flared surface (28) of the planar support structure. In such embodiments with a substantial fillet radius, the fillet radius is defined herein as that radius that may be determined by measuring the maximum sag of the fillet, relative to the edges of the fillet surface; namely, the relevant edges providing the dimensions, d₀, d₁, or d₂. The qualifier “effective” is intended to point out that such fillet radii may deviate from a circular profile, so that the average surface profile designated by radii, r₁ and r₂, may possess parabolic, hyperbolic, roughened, or other non-circular characteristics while still being formed with a net sag in its the profile, as indicated in FIG. 12.

It may be found adequate, in some cases, to provide only the greater through-hole volume (29) provided within the greater flared surface (28), without forming the smaller flared surface, so that the thickness, T₂, of the greater through-hole volume is substantially equivalent to T₁, though it is preferable, under these circumstances that the effective r₂ be relatively small, preferably less that four time the thickness of the planar support structure, such that r₂<4T₀, whereas, in the case that a smaller flared surface is provided, r₁ may be more broadly defined, and may be quite large, or essentially infinite, corresponding to a straight profile.

The free-standing electrolytic film, relative to the periphery of the free-standing region, possesses a net convex aspect. Such convex aspect may be defined by an effective displacement, so, or sag, of a free-standing surface of the electrolytic film from planarity. Once again, it is pointed out that “sag” is defined in its conventional meaning, wherein it refers to a displacement distance, measured roughly from the center of a surface or aspect thereof, by which a surface is curved from planarity. For example, the free-standing electrolytic film may possess various aspherical characteristics; however, an estimated radius of curvature may be obtained by measuring the sag, so, across the lateral dimension, d_{free}, of the free-standing electrolytic film, where d₀=d_{free} in FIG. 12, so that an estimated radius of a corresponding spherical or cylindrical surface of equivalent sag is provided, as is commonly performed in conjunction with sag measuring devices used in measuring surfaces.

The effective displacement from planarity, so of the convex (or, concave) aspects of the disclosed free-standing electrolyte portions will typically lie in a range between 0.0001″ and 0.100″, such that 0.0001″≦s₀≦0.100″. It is found that the smaller flared surface (26) is advantageous for controlling the effective displacement, so, of the free-standing electrolytic film.

The free-standing portion of the electrolytic film can be provided as an adequate stress relieving structure by providing that the ratio, s₀/d_{free}, of effective displacement, s₀, to the lateral dimension, d_{free}, of the free-standing electrolytic film, be sufficient to allow suitable flexure of the free-standing film during the temperature changes (typically 27 C-1000 C) required for operation of the device, preferably such that 0.02<s₀/d_{free}<2.0, and more preferably, 0.05<s₀/d_{free}<0.5. As mentioned earlier, it is preferable that d₀=d_{free}, so that d_{free} is therefore most preferably defined by the constriction surface (27), though the principles and advantages set forth herein may be less preferably realized provided that d_{free}<d₂, and adequate clearance for controlled wetting by the sacrificial material is found to be also provided under the preferable condition that d₂−d_{free}≧0.25 T₀.

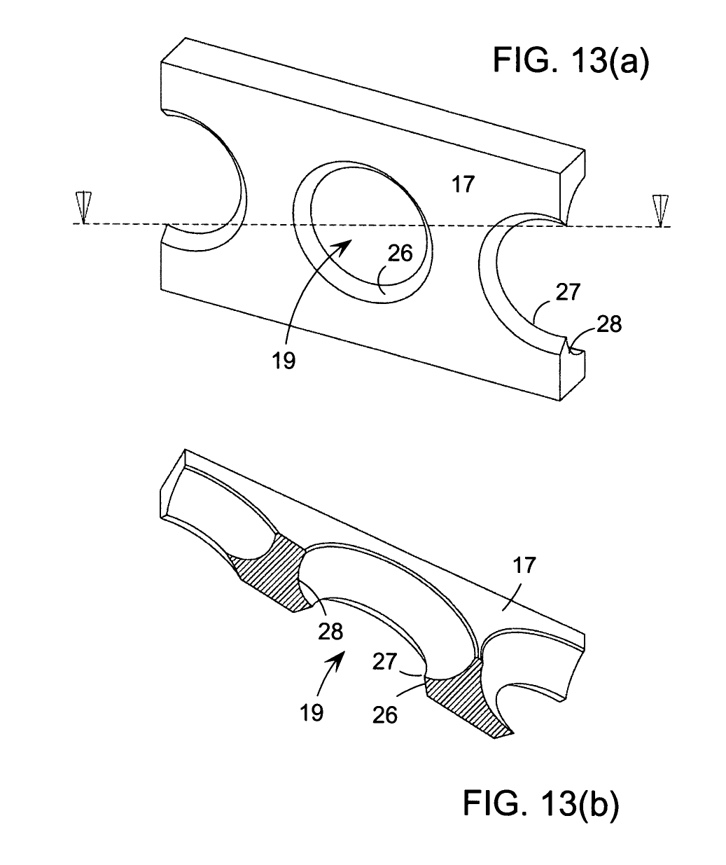

The through-hole structure is not limited to a particular cross-sectional aspect, and may be provided with a variety of through-hole cross-sectional profiles, including angles and curvatures. In a further embodiment of the structure set previously, in FIG. 13(a) and FIG. 13(b), the greater flared surface of the planar support structure is preferably provided with a hollowed out aspect, so that the greater flared surface is provided as a fillet. Such fillet cross-sections are found advantageous for further providing controlled wetting of the planar support structure by the sacrificial material. The greater flared surface (28) of the planar support structure, such as in the through-hole structure in FIGS. 6-7, is preferred for providing reliable wetting characteristics of the sacrificial material in the production of a resultant free-standing electrolytic layer having a convex aspect. As in FIG. 12, it is also preferred there be a smaller flared surface (26) at the intersection of the through-hole structure with the first surface. In accordance with the embodiments of FIG. 12, the greater flared surface (28) of the second surface is greater in depth for accommodating the convex aspect of the free-standing electrolytic film.

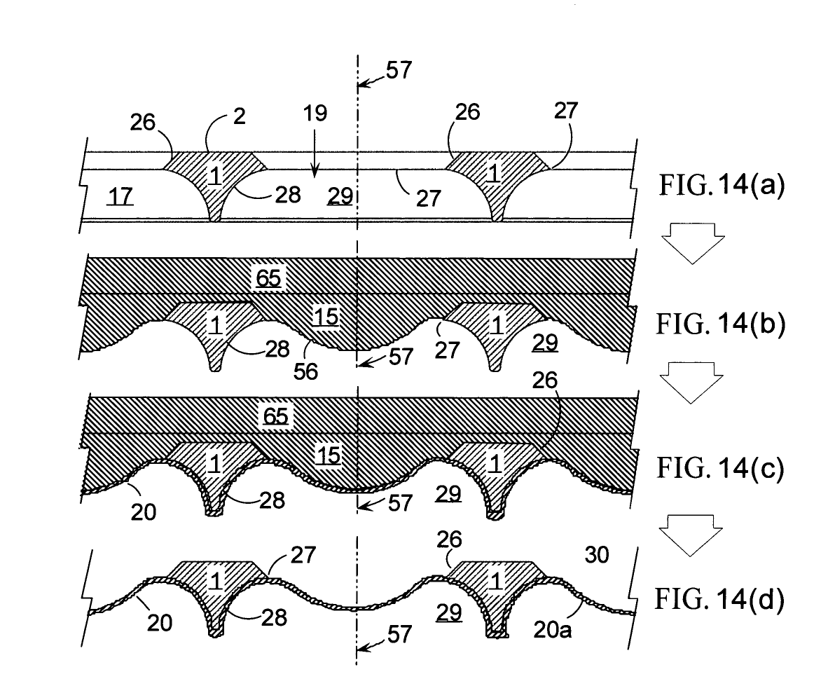

In an another embodiment of the preferred process for forming the free-standing electrolytic film, in FIG. 14(a-d), the planar support structure with through-hole features is again processed through different stages of a process flow wherein a polymeric sacrificial material is utilized in accordance with the previously embodied methods and structures so as to form the free-standing electrolytic film.

The planar support structure, in FIG. 14(a), is preferably formed from a thin metal sheet, which may be obtained in a commercially available milled form referred to variously as a foil, sheet, rolled metal, or strip. The metal sheet is subsequently patterned with a plurality of through-hole structures, in FIG. 14(a), similar to previous embodiments. The through-hole pattern of the present embodiment is preferably formed by etching, and most preferably, etching by photochemical machining, such as is available from such photochemical machining vendors as E-Fab Inc., Acu-line corp, Suron Ltd., etc. The finish of the metallic support structure may comprise various surface treatments, including various additional etching, pickling, polishing, electro-polishing, electroless polishing, and coating processes. It is preferable that the structure be electro-polished for smoothing purposes, and subsequently overcoated with the diffusion-barrier coatings disclosed herein, wherein at least one surface is coated with the electrically conductive oxide/inert metal layer system disclosed herein. It is also found advantageous, in the event of the use of the presently disclosed planar support structure for fuel cell applications, that the fuel-side surface of the structure, where metal alloy surfaces are exposed to the fuel atmosphere of the solid-oxide fuel cell (SOFC), that the fuel-exposed metal be coated with an alternative embodiment of previously disclosed coating systems, the alternative embodiment comprising the use of either Lanthanum Hexaboride (LaB₆) or a, preferably strontium-doped, lanthanum cuprate (La₁₋ₓSrₓCu_{y}O_{z}) as the first layer, and with Nickel preferably as the second layer.

The through-hole pattern is subsequently covered with a sacrificial material, in FIG. 14(b), such that the through-hole pattern is sealed by the sacrificial material, wherein the specific aspect of the set sacrificial material is determined by its wetting characteristic in conjunction with the specific surface chemistry terminating the planar structure before application of the sacrificial material, so that the wetting angle of the sacrificial material may be tailored to provide a variety of sacrificial material shapes. It is preferred that the sacrificial material be laminated to the structure so that the resulting meniscus (56) of sacrificial material is provided at the constriction surface (27), and preferably made convex in its wetting, preferably melted, state, in FIG. 14(b). In this way, the convex, preferably polymeric, sacrificial material preferably provides the desired convex profile prior to solidification, which, in addition to preferred melting and solidification of the polymer, may alternatively require curing or thermoset of a polymeric sacrificial material. In this way, the subsequently deposited electrolytic material is preferably provided its profile as essentially identical to that of the meniscus.

Various texts have become available during the previous decades describing the rheology, wetting characteristics, and compositions of organic polymers used for lamination of metal surfaces and topographies. In the embodiments of FIG. 14, the sacrificial material that fills the through-holes is preferably an organic material, and more preferably a homopolymeric material, such as polyethylene, having a suitably low glass transition temperature, T_{g}, so that the polymer may be readily wetted to the planar structure.

In accordance with the present embodiment, the smaller flared surface (26) provides a surface on which the sacrificial material is preferable disposed, so that the surface provides a wetting edge for the wetting material. In the present embodiment, it is preferable that the sacrificial material be disposed over the planar support structure as a compound structure that includes two layers, wherein one layer is a secondary polymer film (65) that is preferably of a polymer of higher glass transition temperature, T_{g}, than the transition temperature of the, preferably polymeric, sacrificial material (25) that fills the through-hole structure. It is also preferable that the secondary polymer film be provided as a stretched polymer, such as a Mylar® or other such rolled plastic sheeting, wherein the secondary polymer film is preferably laminated with the sacrificial material.

It is preferable that the wetting angle of the sacrificial material to the exposed metal surfaces of the planar support structure be adequately large to provide a barrier of surface energy that prevents substantial wetting of the greater flared surface (28).

It may be readily appreciated that a variety of wetting behaviors and resultant sacrificial material shapes are possible for providing a substrate for subsequent deposition of the electrolytic film. While it is a preferred embodiment that the sacrificial material be disposed so as to deposit electrolytic material over the first side of the planar support structure, it will be readily appreciated that it is equally possible provide the convex free-standing elements of the present disclosure by wetting sacrificial material to the first side of the planar support structure, the sacrificial material disposed so as to deposit electrolytic material over the second side of the planar support structure, wherein the electrolytic film will accordingly acquire the shape of the preferred convex meniscus formed by the sacrificial material. In this latter embodiment, the solid oxide film (20), in is FIG. 14(c) is accordingly deposited on the sacrificial material and planar support structure from the second side of the planar structure. The resultant electrolytic film (20) with free-standing region (20a) is thus formed in an alternative embodiment to FIGS. 4-7, in that the film of the present alternative embodiment is formed on the same side of the planar substrate as the convex aspect of the free-standing portion (20a) of the electrolytic film, or equivalently, on the same side as the greater flared surface (28).

The sacrificial material is removed, in FIG. 14(d), to provide the free-standing electrolytic film, as in previous embodiments. It is preferable and advantageous that stress relieving structures comprising the convex, free-standing portion of the electrolytic film be disposed entirely between planes comprising the first and second surfaces of the metallic support structure, in FIG. 14(d), so that the resultant electrode/electrolyte assembly (30) does not provide an electrolyte surface protruding substantially beyond the electrolyte deposited onto the metallic support structure, and so that the free-standing electrolyte is thus protected within the respective through-hole feature in which it is formed.

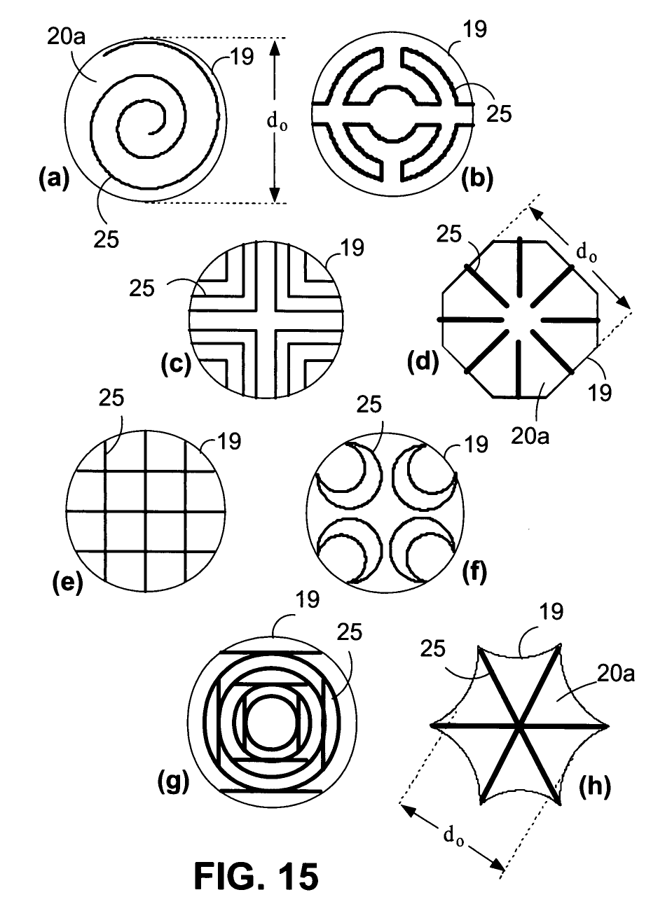

Alternative embodiments of electrode material (22) deposited over the free-standing electrolytic film may include patterned electrode structures (25), in FIG. 15(a-h). structures may be deposited on the electrolytic film. Such electrode layers (22) that are formed over the free-standing portion (20a) of the electrolytic film that is formed in the through-hole feature (19) may be embodied in a variety of patterned and non-patterned layers. Patterned layers may be formed in any shape or pattern, including helices, spirals, crossed metal traces, radial star-shaped metallic traces, etc., provided any such patterned layer does not degrade integrity of the free-standing electrolytic film for the desired operation. Accordingly, any of the thin film methods outlined herein may be utilized for application of the electrode materials, including the various vapor deposition means, inkjet printing, misting means such as metal-organic decomposition, ALD, silk-screening, etc. Ink-jet printing is particularly preferred as means for the deposition of electrode or catalytic material on formed electrolyte layers of the present invention. Also, means for patterning the electrode layers may also comprise any suitable means, including use of shadow masks, etching, various lithography means, selective deposition means such as inkjet printing, or any other appropriate additive or subtractive process.

FIG. 15(d) and FIG. 15(h) the constriction dimension, d₀, which preferably defines the lateral dimension of the free-standing electrolytic film, need not be ascribed to only strictly circular dimensions, since a variety of circularly symmetric, irregular, and otherwise oblong through-hole features may provide varying dimension without departing from the spirit or scope of the invention. In particular, in FIG. 15(d) and FIG. 15(h), the through-hole feature may be roughly octagonal, hexagonal, or star-shaped, while still providing the preferred circular symmetry. Alternatively, under the previous relationships provided for the dimensions of the through-hole features in a given cross-sectional plane, the opening of the through-hole feature may be otherwise irregularly shaped, though, it is preferable that it have a circular symmetry of a circular opening or a roughly circularly-symmetric polygonal opening.

In the present embodiment, a patterned electrode film is preferably applied to the free-standing electrolytic film in the pattern of a flexure structure, so that free flexure of the free-standing electrolytic film is maintained. It is preferred that the patterned electrode be provided in the form of a flexure structure, so as to preserve the stress-relieving characteristic of the free-standing film. In some cases, the electrode material may simultaneously reinforce or otherwise protect the electrolytic film. Accordingly, the patterned electrode will preferably possess the aspect of a flexure structure, such as in FIGS. 15a, 15b, or 15g. Such flexure structures may be made to have the aspect of a disk spring, such as those used in acoustic speaker designs, or any suitable planar disk-spring structure set forth in texts on flexure devices. Alternatively, various other electrode patterns may also be readily employed. While various catalytic, reforming, or other functional materials may be incorporated into the electrode structure, it is primarily noted for sustaining an electrical current, and preferably incorporates accordingly electrically conductive materials such as the various electrode materials cited herein.

Because of the increased density of cell area per volume, which is provided by the disclosed electrolytic membranes relatively small dimensions in thickness, it is thus possible to provide an effective power density, P, that is equivalent to the power per unit volume provided by a multitude of cells, wherein several of the disclosed cells can occupy the same volume as one cell of the prior art, due to a thinner cross-section afforded in the disclosed cells. As a result, much lower power densities may be provided at an individual cell of the present invention, relative to thicker cells, whereas the effective power density can be equivalent.

Accordingly, the current density, I, across one individual electrolytic membrane, may also be lower than an equivalent-capacity electrolytic device of the prior art using conventional bulk tape-cast electrolytes, since the thinner aspect of the disclosed electrode/electrolyte assembly provides for relatively greater electrolyte surface area per unit volume.

It is well known that electrolytic membranes with decreased thickness provide accordingly higher current densities; such results may be provided by the accordingly larger electrical field existing across the thickness of the solid oxide electrolyte. It is further well known that such thinner electrolytes may also be operated at significantly lower temperatures for achieving a given current density across the membrane.

Disclosed electrolytic device structures are particularly suited to deposition processes wherein the deposition of material on the alloy element is provided in a roll-to-roll process. Such roll-to-roll processing is particularly suitable due to the contained and protected aspect of the free-standing electrolytic film, which is protected from abrasion, puncture, or fracture in subsequent rolling processes, due to the free-standing film being disposed within the through-hole features, so that the free-standing electrolytic film is thus protected within the respective through-hole features of the planar support structure during subsequent processing, assembly, and operation of resulting electrolytic device.

Accordingly, such methods as photochemical machining, broaching, shearing, machining, laser cutting, laser welding, reactive ion etching, stamping, electrolytic polishing, electroless polishing, etc. may be utilized as subtractive processes to form the disclosed surfaces. Alternatively, such additive processes as plating, electroforming, ink-jet printing, vapor deposition, CVD, sputtering, evaporation, liquid phase epitaxy, solid state phase transformations, brazing, soldering, reflow, solgel, dip-coating, spray coating, plasma spray, thermal spray, spin-casting, solid casting, powder casting, etc., may be utilized to form the disclosed metallic structures, as well as the other structures disclosed herein.

Furthermore, any variety of deposition methods appropriate for forming solid (including porous) thin films of the preferred embodiments may be utilized to form the thin film structures of the disclosed embodiments. Accordingly, any sputtering, evaporation, e-beam, CVD, ALD, spin-coating, MOD, laser deposition, etc, as these thin film deposition methods are represented in the prior art of thin film methods, may be utilized in forming structures of the present disclosure. A desirable process approach may involve post-annealing to provide proper phase development or stoichiometry, such as in the case that a post-anneal in oxygen-containing environment provides additional oxidation of the preferred oxide films of the invention, as, for example, in the case that the electrolyte is deposited in a reduced form.

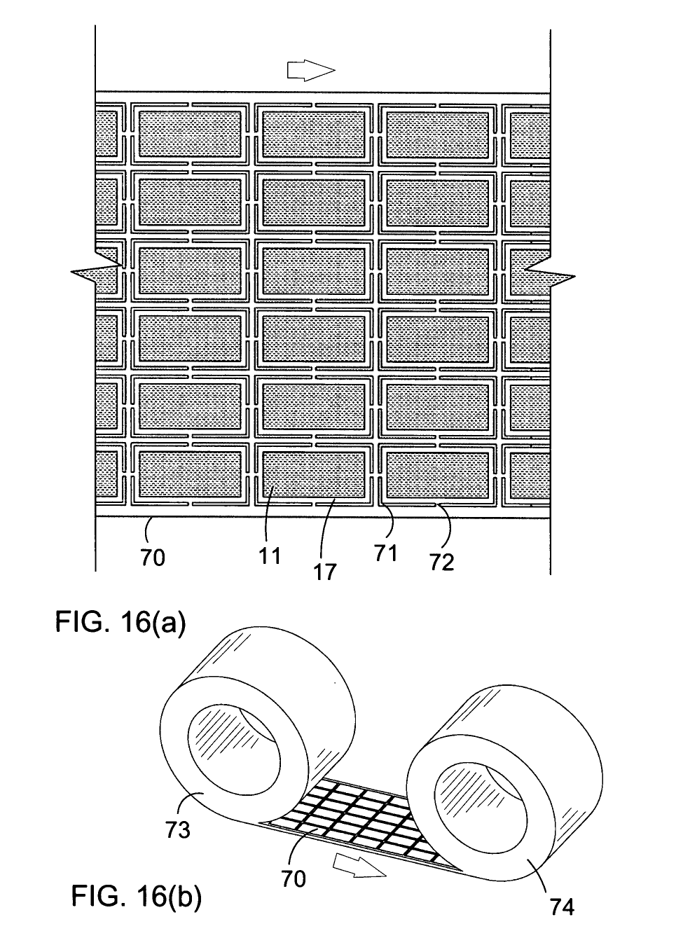

The embodiments set forth herein are particularly suitable for economical in-line production of electrolytic devices. In particular, the thin metal sheet may be processed in a series of roll-to-roll processes for producing a large array of the electrode/electrolyte assemblies (30). The planar electrode support structure (17) are accordingly preferably produced in photochemically etched sheet metal with etched-through channels (71) for separation of the planar elements, in FIG. 16(a), with remaining tabs (72) for retention of the planar elements in the original sheet for large-scale processing of multiple planar elements. As previously discussed, the planar electrolytic cell structures set forth herein may be readily embodied in a variety of cell shapes, including circular, rectangular, or polygonal cells. Accordingly, the planar electrode support structure (17) of FIG. 16(a) comprise rectangular structures for most efficient use of the metal sheet; however, any shape, including the circular planar support structures of previous embodiments, may as easily be patterned into the rollable metal sheet.

It is accordingly preferred that an alloy metal sheet of the preferred embodiments be patterned for providing one or more planar elements of the disclosed electrolytic device. In accordance with the first preferred embodiments, the region of through-hole features (11) provided in the thin metal sheet are subsequently covered with the preferably polymeric sacrificial material, in accordance with the preferred embodiments, so that a resultant flexible assembly of the parts is provided in a rollable sheet (70), in FIG. 16(a), wherein the rollable sheet is so named by virtue of being suitably compliant and formed for rolling into a wound roll; thus, the rollable sheet incorporates a multitude of the planar support structures with sacrificial material attached.

Such roll-to-roll processing may similarly be used to flexibly produce the various sheet metal components disclosed herein, such as bimetal interconnect plates, end plates, etc., by similarly etching the various components into a running length of metal sheet or strip. Accordingly, the rollable sheet may be subsequently transported from a first supply roll (73) of the rollable sheet to a second uptake roll (74) of the rollable sheet, in FIG. 16(b), so that the exposed side of the sheet may be instantly coated with electrolytic layers, and processed with various other coatings and processes discussed herein. It is preferable to minimize plastic deformation of the metal sheet, so that the supply roll and uptake roll preferably are possessing a relatively large minimum radius, relative to the cores and core-chucks utilized for typical roll-to-roll coating of plastic films and sheet. Accordingly, it is preferred that the rolls embodied herein possess core diameters (outer diameter of the core) corresponding to the inner diameter, d_{c}, of the roll of preferably greater than 8″, and more preferably, greater than 20″. Additionally, in accordance with the embodiments providing a protective barrier coating or diffusion barrier coating, such coatings are preferably web-coated similarly onto the metal sheet in a roll-to-roll process prior to lamination of the sacrificial material.

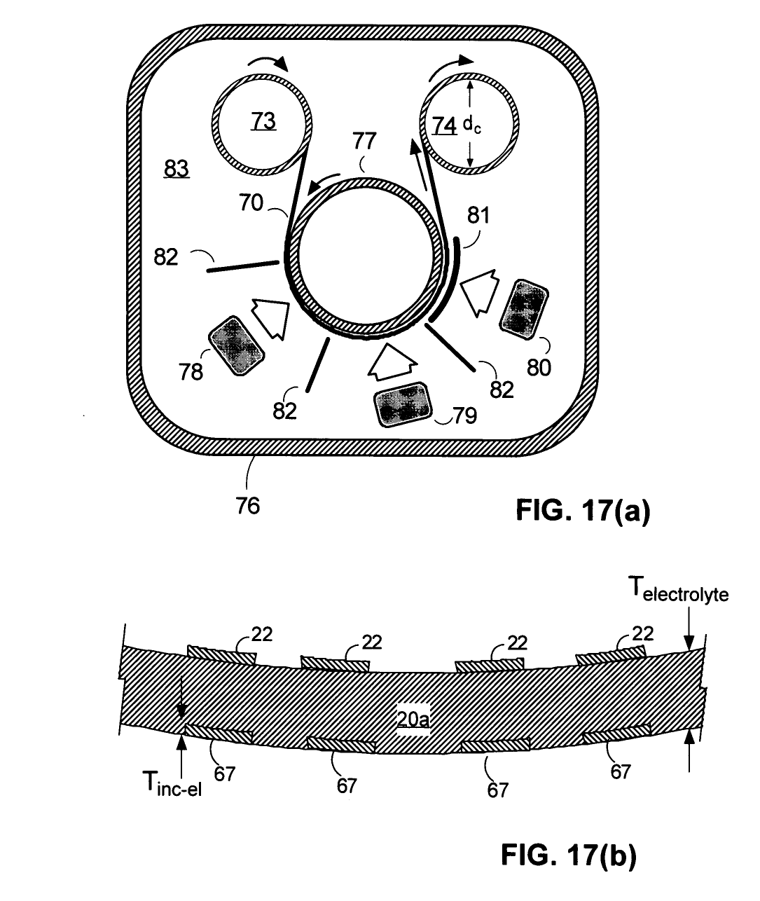

It is preferable that the embodied rollable sheet be processed in a vacuum deposition chamber, preferably having a web-handling capability, for deposition of the various material layers of the preferred embodiments. A web-coating system commonly utilized for vacuum-coating flexible substrates may be readily employed, in FIG. 17(a), wherein a preferred layout of vapor sources and deposition stages is provided. Typically, a vacuum chamber structure (76) is provided for providing an interior vacuum process space (83).

As is common to web-coating apparatus, a temperature-controlled drum (77) is preferably utilized for controlling deposition temperature of the rollable sheet (70) during deposition of material, the rollable sheet preferably in thermal contact with the drum during deposition of material. A first vapor source (78), which is preferably a linear magnetron sputter source, provides deposition of the electrolytic material onto the exposed metal surface of the rollable sheet, thereby providing the electrolytic thin film. A second vapor source (79) may be utilized for providing a second electrolytic material in a mixed, nanolaminate, microlaminate, or otherwise modulated combination with the first electrolytic material. A third vapor source (80) is preferably utilized for deposition of electrode materials and structures over the previously deposited electrolytic film. The various flexible electrode structures embodied in the present invention are preferably fabricated by means of a shadow mask (81), which shadow mask is positioned between the third vapor source and the rollable sheet via suitable alignment means for depositing electrode shapes described herein, such as those set forth in FIG. 15.

It may be readily seen that the vacuum process chamber of the preferred embodiments is suitable for depositing patterned electrode layers over the planar support structures incorporated in the rollable sheet. It may also be seen that the patterned electrodes, as embodied in FIG. 15, may also be deposited prior to forming the electrolytic layer, so that a flexible electrode layer may be formed before the deposition of the electrolytic film. In this embodiment, it is preferred that the underlying patterned electrode be substantially coplanar to, and incorporated in, the electrolytic film, in FIG. 17(b), and that the thickness be relatively small compared to T_{electrolyte}, so that the thickness of such an incorporated electrode, T_{inc-el}, be less than 0.2 T_{electrolyte}, and more preferably, T_{inc-el}≦0.05 T_{electrolyte}, so that mechanical integrity of the free-standing electrolytic film is not compromised. Such incorporated electrodes (67) would typically comprise a relatively ductile material, such as solid platinum or nickel, though conducting oxides such as those used for the first layer of the diffusion barrier of FIGS. 1-2, may also be utilized.

Typically, baffles (82) are utilized in the chamber to maintain separate deposition zones, though a variety of in-line, cluster-tool, and pallet coating processes may be envisioned that utilize load-locking and separate chambers for the vacuum processes described herein, as is commonly practiced in the art of vapor deposition. Of course, various other vapor sources, activation means, and etching means may be additionally utilized for further modification of the vacuum processing means embodied herein.

The planar electrode support structure is preferably a metal strip or foil, produced by rolling or other milling procedures common to the art of producing metal foil and strip. The metallic support structure preferably comprises a metal of the compositions and metallic phases suitably matched in thermal expansion to the thermal expansion of the solid oxide electrolyte. Accordingly, depending upon the specific electrolyte used, the metallic support structure may comprise a stainless steel of austenitic, ferritic, martensitic, or other such metallic phases of commonly available stainless steels, including various specialty alloys available through commercial producers such as Allegheny Ludlum or Carpenter. For example, in the case that the electrolyte is rare-earth-stabilized bismuth oxide, it is preferable that the support structure is an austenitic stainless steel, such as 304, or 316. In the case that the electrolyte is YSZ, then it is generally preferable that the support structure is of a ferritic or martensitic stainless steel.

Solid oxide electrolytes of the present invention may comprise any solid oxide material suitable for providing electrolytic behavior, namely, those having oxygen ion conductivity's high enough to qualify such oxides as “fast” ion conductors. Accordingly, such solid oxide electrolytes of the present invention may include, but are not limited to, materials containing stabilized zirconia (e.g. Yttria- or rare-earth stabilized), bismuth oxide, cerium oxides, gadolinium oxides, and various substituted or mixed oxide compounds.

One advantage of the disclosed metallic support structure is that, for a given degree of stress experienced as a result of differences in thermal expansion between various materials of the resulting electrode/electrolyte assembly, the planar support structure may itself provide a degree of flexure to accommodate such stress, though, it is preferred in the first embodiment that substantially all stress-relieving flexure is provided by the free-standing electrolytic film.

A further objective of the presently disclosed membrane is that the surface area of electrolyte provided to the oxygen-yielding side, or fuel side in SOFC devices, of the electrolytic membrane, is preferably smaller than the surface area of the electrolyte exposed to the air-side, or oxygen-absorbing, side of the electrolytic membrane, so that reducing tendencies of the oxygen-yielding surface of the membrane are counter-balanced by a greater oxygen-absorbing surface area of the membrane. Such conditions are met in the embodiments of FIG. 14(c), wherein the electrode/electrolyte assembly provides greater electrolyte surface area on the second side, corresponding to the side of greater flared surface (28), then the electrolyte surface area of the electrolytic film that is exposed at the first side, corresponding to the side of the planar support structure with smaller flared surface (26), so that a difference in electrolytic surface area is provided between the two sides of the electrode/electrolyte assembly (30). In such circumstances, it is preferable for solid oxide fuel cells incorporating such embodiments to utilize the second side as the fuel side of the respective cell incorporating such embodiments.

Such non-planar aspect may be further controlled through the wetting characteristics of the metal surfaces prior to application of the sacrificial material, wherein various preliminary surface preparations and cleaning methods may be envisioned, including glow-discharge cleaning, ultrasonic cleaning, ultra-fine bead-blasting, or application of some substance for modifying the wetting-angle of the sacrificial material.

An advantage of the present invention is that more economical fabrication means may be utilized for forming structural elements of the disclosed electrolytic structures, since all structural or bulk elements are readily fabricated by methods of metal alloy foils or sheet metal fabrication. In a preferred embodiment, photochemical machining is utilized to provide economical fabrication of the thin metal part of the present invention.

In the present invention, corrosion, or diffusion, barriers comprising a multilayer thin film structure may utilize any number of carbides, borides, or oxides. It is also an alternative embodiment that underlying layers of the diffusion barrier be electrically non-conductive, such that the electrically-conductive outer layer or layers provide the majority of electrical current. Such latter embodiments are enabled by the relatively compact nature of the disclosed electrolytic cell, wherein the relatively small volume occupied by the cell, combined with large effective electrolyte surface area, allows for smaller current densities to be realized for the same per-unit-volume power generation, or alternatively, oxygen/hydrogen generation.

Porous catalysts, such as lanthanides, manganates, LSM, LSCMO, nickel, ruthenates, etc. may be vapor deposited over the electrolytic membrane in thin-film layers preferably less than 10 microns, in thickness that preferably does not interfere with flexibility of the free-standing film.

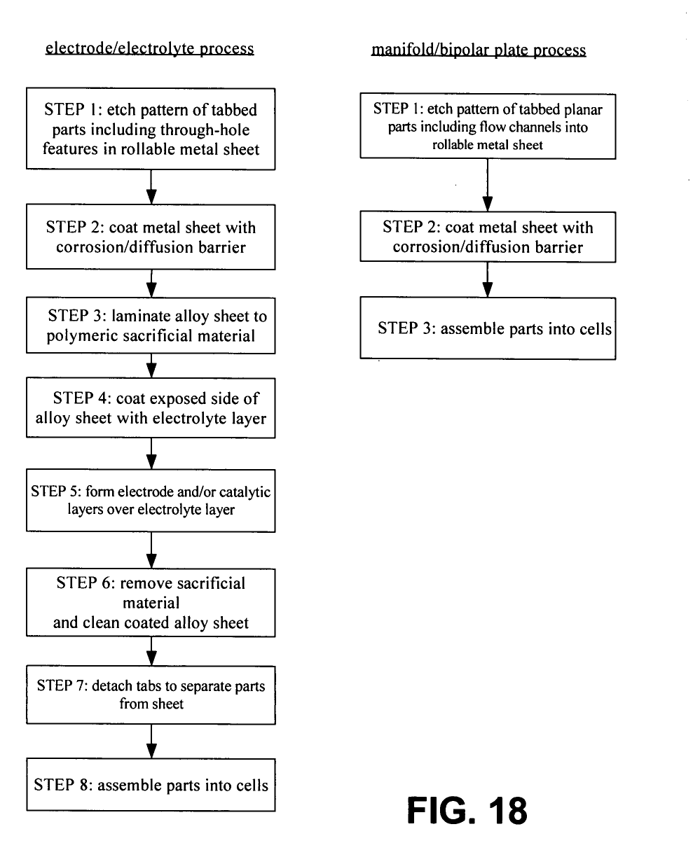

A preferred process flow, in FIG. 18, may be delineated for fabrication of the electrode/electrolyte assembly (30), as well as the interconnect components of the disclosed electrolytic device.

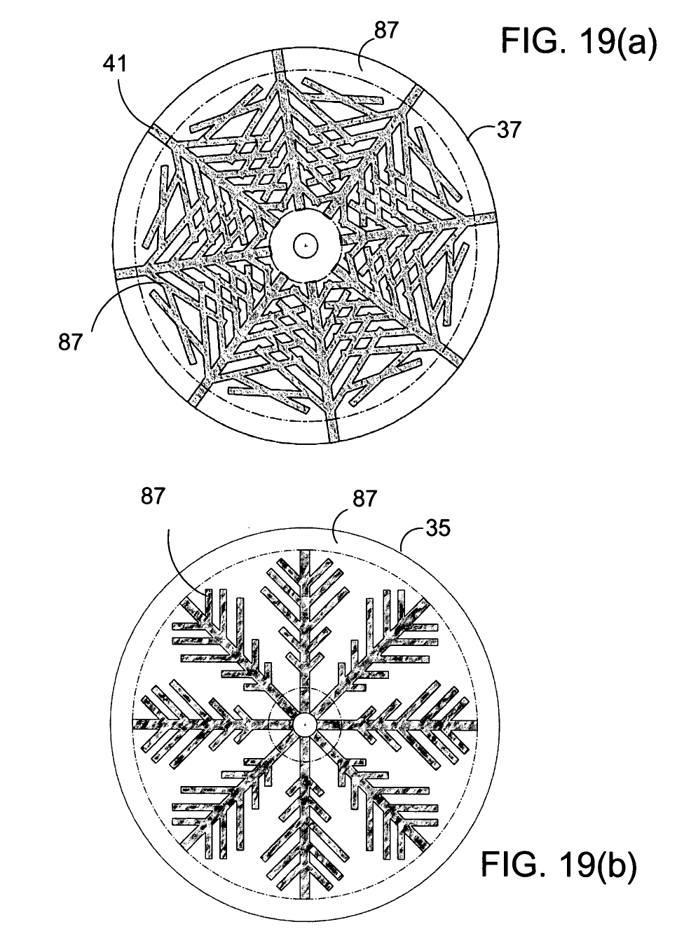

An alternative preferred embodiment of the inventive electrolytic device is provided, utilizing chemically etched, and preferably, photochemically etched, thin metal sheet for gas conveying structural components of the electrolytic cells, in FIG. 19, wherein dendritic gas channels are etched in the bipolar interconnection elements and the endplates. It is additionally preferred in the presently disclosed embodiments of FIG. 19, that the etched flow channels (87) be dendritically shaped. Accordingly, the resultant dendritic flow channels may be lithographically formed through photomask means as is common to photochemical etching, so as to provide a pre-determined shape of the flow channels; or, alternatively, the flow channels may be formed by the chemical kinetics of the solution etching process, so that a relatively random pattern of the desired dendritic shapes is produced.

The etched metal sheet comprising manifolds and bipolar interconnect plates of the current embodiments, in FIG. 19, is preferably 0.0005″ to 0.050″ (inches) in thickness, and more preferably, 0.002″ to 0.020″ (inches) in thickness

Etched depths of the flow channels, in FIG. 19, are preferably etched in the range of 0.001-0.010″ (0.001-0.010 inches), though greater or smaller etch depths may readily be implemented. Also, while radial cell geometry's are particularly pointed out in the preferred embodiments, it may be readily appreciated that any of a wide variety of shapes of the prior art may be likewise utilized, such as square or rectangular cells, polygonal cells, etc. Likewise, etched flow channels may readily be formed in any flow-channel shape of the prior art that is suitably applied to etching methods set forth herein. Such methods are used to fabricate the cathode-side gas manifold (35), in FIG. 19(a), as well as to fabricate the anode-side gas manifold (37), in FIG. 19(b).

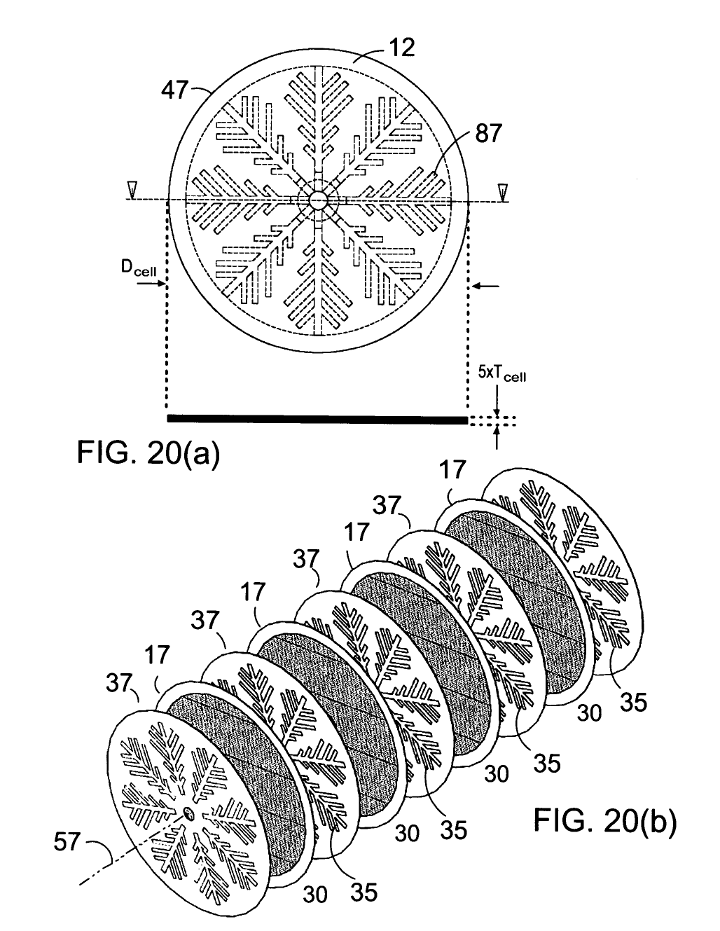

The dendritically etched manifolds, in FIG. 19, are preferably incorporated in an electrolytic device so as to provide delivery of such gases and vapors that are desirable for operation of the device, preferably in accordance with embodiments set forth herein. A preferred embodiment of the inventive electrolytic device utilizing chemically etched thin metal sheet for all structural components of the electrolytic cells is accordingly provided, in FIG. 20, that incorporates the embodied etched manifolds and etched planar support structures.

Another advantage of the present invention is a short heat-up and cool-down time period, relative to prior art solid oxide electrolytic systems, such as fuel cells and oxygen generation systems. The electrolytic device structures set forth in the present invention are found to provide relatively small heat-up and cool-down times, wherein temperature changes between room-temperature and operation temperatures, comprising temperature difference of greater than 700 C, is executed in less than ten minutes, without any fracture of the solid oxide electrolyte. The cathode-side gas manifold (35) and the anode-side gas manifold (37) may accordingly be incorporated into opposite sides of bipolar interconnect plates that are fabricated from the preferred rolled metal sheet in thickness' slightly larger than that required to form the opposing flow channels of the respective manifolds.

A typical planar dimension, D_{cell}, of the planar electrolytic cell dimensions across the substantially planar direction are preferably in the range of 0.1″ to 10″ in the greater dimension of an individual cell, the cell possibly being rectangular, square, elliptical, or polygonal in its planar shape. An advantage of the present invention is that a stackable, all-sheet-metal structure, electrolytic cell is provided, wherein all structural elements are fabricated from commercially available sheet metal. Decreased thickness of individual cells may thus be realized through use of such thin layers of rolled metal sheet, so that the individual planar electrolytic cells of the preferred embodiments may be readily fabricated that possess a total average thickness, T_{cell}, normal to the planar aspect, of less than 0.030″, and preferably less than 0.010″

It is noted herein that a convex surface feature having a sag, s₀, may comprise any one or a combination of surface figures. For example the functionally convex surface of the disclosed electrolytic film may be incorporated in a gaussian aspect, a bell-curve, a sinusoidal aspect, a parabolic aspect, a hyperboloidal aspect, or any other aspherical aspect, without departing from the scope and spirit of the present invention. Such alternative surface shapes may be regarded as acceptable, insofar as such shapes satisfy the stated objective of the present invention, which is to provide a convexity in the surface of the free-standing electrolytic film, so that the free-standing film may be strained or flexed by a changing hole dimension, relative to the free-standing film, without fracture of the film.

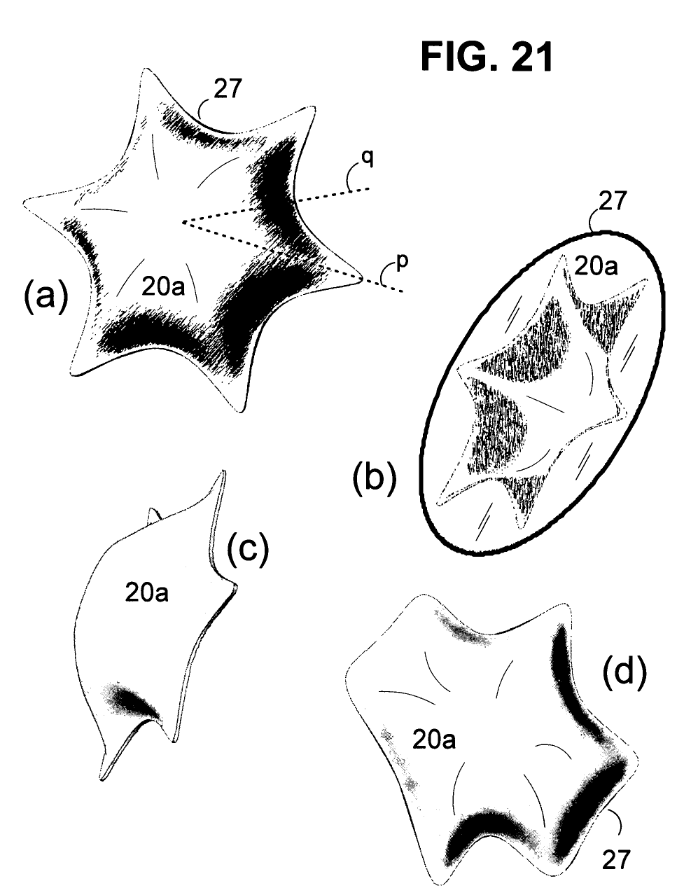

For example, the figure of the film may be provided as hyperbolic, elliptical, spherical, aspheric in any fashion, symmetric, asymmetric, continuous, noncontinuous, eccentric, wavy, or any other profile that enables the film to span and seal the hole, so as to provide leak-free performance that is desired for the solid oxide electrolytic devices addressed herein. Convex aspects may comprise a variety of spherical, aspherical, creased, or an otherwise non-planar cross-sectional figure that provides a flexibility by virtue of the ability of the electrolyte to flex. The free-standing electrolytic film may be provided with a variety of irregular aspects having the embodied convex aspect, wherein aspects of the free-standing film may depart from concentricity. For example, the methods and structures may be readily embodied as various wrinkled shapes, shapes with crevices, or modulated shapes providing combinations of concave and convex surfaces, in FIG. 21(a)-(d). Similarly, irregularity in the through-hole pattern may also exist without departing from the principles and scope of the present invention.

As a further example, such polygonal or star-shaped through-hole openings as previously discussed will often result in a free-standing electrolytic film that has a similarly shaped boundary with the planar support structure. Such boundary shapes will often result in sacrificial-material wetting characteristics that provide a radially furrowed, folded, or wrinkled shape of the free-standing electrolytic film towards its outer perimeter, in FIG. 21(a)-(d). For example, in FIG. 21(a), a first radial dimension p, comprises a longer radial dimension of the free-standing film than a second radial dimension q, so that the resulting free-standing electrolytic film is found to possess a ridge along p relative to a furrow along q. Such radial furrows and other irregularities may be provided in functioning free-standing films of the present invention. Such radial furrow and ridge structures may be formed in circular through-hole feature, as well, in FIG. 21(b). Similar, roughly radial, furrow and ridge shapes may be realized in relatively irregular through-hole features, in FIG. 21(d).

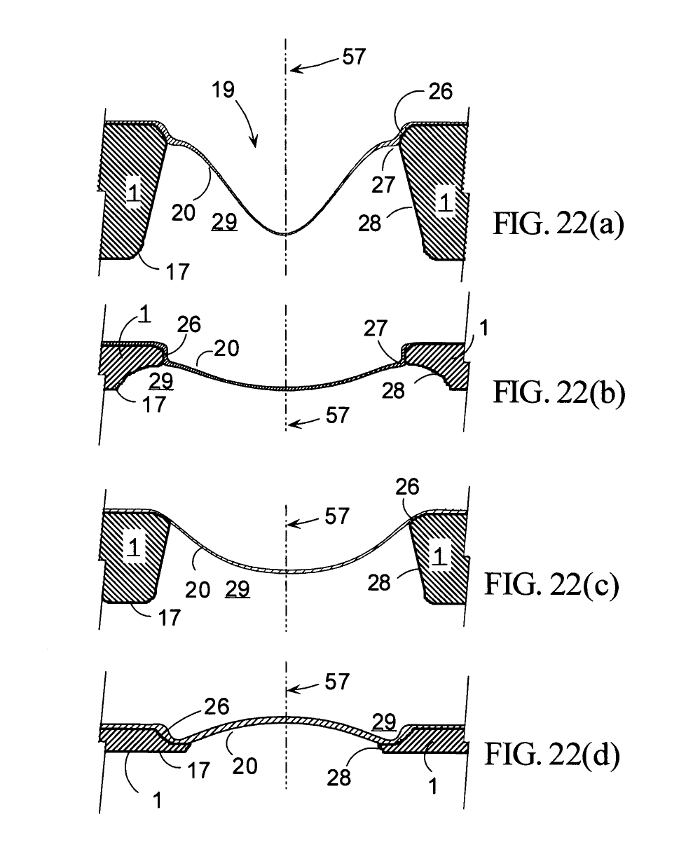

For example, in an alternative embodiment, the free-standing electrolytic film is varied in its thickness across its free-standing aspect, in FIG. 22(a), wherein the freestanding electrolytic film is thicker, by a multiplied factor of 1.25-10.0, at its edges adjoining the supporting through-hole structure than it is in the center of the freestanding electrolytic film, preferably in a continuous fashion, so that flexure of the free-standing film is reduced at its interface to the planar support structure.

The free-standing portion of the electrolyte may thus comprise one of many possible nonplanar aspects or profiles including cross-sectional profiles that include a combination of a gaussian and a trapezoidal aspect, in FIG. 22(a), a cylindrical and a spherical aspect, in FIG. 22(b), or some other aspherical aspect that is disposed within the preferably circular hole structure, in FIG. 22(c) and FIG. 22(d).

The disclosed free-standing electrolytic films comprise stress-relieving structures that flex in response to temperature changes of the electrolytic device, so that the supporting structure may possess a different thermal expansion coefficient than that of the electrolyte. Accordingly, the embodiments set forth herein are seen as particularly advantageous for utilizing electrolytes and planar support structures that differ from on another by an, otherwise undesirable, difference in coefficient of thermal expansion, or ΔCTE. Particularly, the embodied structures and methods are preferred for such differences in coefficient of thermal expansion, ΔCTE (1/° C.), wherein such difference comprises 0.5 ppm<ΔCTE<3 ppm, or, in other words, the difference ΔCTE=0.5-3.0×10⁻⁶/° C. During periods of increasing temperature, whether the free-standing electrolytic film becomes slightly more convex or less convex, depends on whether the supporting hole structure expands or contracts relative to the free-standing electrolytic film.

Porous electrodes used may comprise any material previously found effective in the art of solid oxide electrolytic systems. Accordingly, cathode side electrodes may include various cathode materials of the prior art such as LSM, LSM/YSZ composites, LaSrFeO, Pt, or (silver)Ag/TiO₂ mixtures for the cathode layer. Anode materials may similarly include any of a variety of materials, including those provided in past solid oxide electrolytic devices, such as heterogeneous metal-oxide/Ni layers, wherein the metal-oxide is similar in composition to that of the electrolyte.

Mixed-conductor electrolytes may also be utilized in conjunction with the disclosed embodiments, which electrolytes conduct both negative and positive ions, typically oxygen ions and hydrogen ions, may also be utilized in conjunction with the preferred embodiments. As previously cited, such materials may be polycrystalline or, alternatively, nano-crystalline, wherein the material can be effectively amorphous by x-ray diffraction (XRD). Electrolytes may include doped zirconias, ceria (such as gadolinia-doped ceria), Scandia-doped zirconia, various bismuth-oxide compounds, as well as any other solid oxide of appropriate oxygen conductivity.

Although the present invention has been described in detail with reference to the embodiments shown in the drawing, it is not intended that the invention be restricted to such embodiments. It will be apparent to one practiced in the art that various departures from the foregoing description and drawings may be made without departure from the scope or spirit of the invention.

What is claimed is:

1. A solid oxide fuel cell having a monolithic electrolytic assembly, comprising:
a.) a thin planar support structure formed from a substantially non-porous material, the planar structure having a first side and a second side, the structure patterned with a plurality of through-hole structures, the through-hole structures each having a hole interior surface extending between the first side and the second side, the hole interior surface defining an opening in the support structure, an electrolytic layer disposed within each through-hole structure, the electrolytic layer having a first layer side and a second layer side, the electrolytic layer comprising a solid oxide electrolyte, the electrolytic layer having a first region wherein the first layer side is attached to the interior surface, the electrolytic layer having a second region wherein the first layer side is not attached to the interior surface, the second region spanning the opening, the boundary between the first region and the second region characterized by a contact angle between the first layer side and the interior surface, the contact angle less than twenty degrees.

2. The solid oxide electrolytic device of claim 1, wherein the planar support structure comprises a metal structure coated with at least one material layer.

3. The solid oxide electrolytic device of claim 1, wherein the electrolytic function is that of a gas separation device.

4. The solid oxide electrolytic device of claim 1, wherein the electrolytic function is that of a fuel cell device.

5. A solid oxide gas electrolytic device, comprising:
a.) a plurality of monolithic electrolytic assemblies, the electrolytic assemblies each comprising a substantially metallic structural component, the structural component having a thin planar aspect with a first side and a second side, the structural component having an active region providing an electrolytic function;
b.) a plurality of bipolar interconnect structures interleaving the electrolytic assemblies, the bipolar structures comprising sheet metal, a plurality of gas channels formed into the bipolar structures by chemical etching.

6. The solid oxide electrolytic device of claim 5, wherein the electrolytic function is that of a gas separation device.

7. The solid oxide electrolytic device of claim 5, wherein the electrolytic function is that of a fuel cell device.

8. A method for forming a solid oxide electrolytic assembly, comprising the steps:
a.) forming a structural element from a flexible metal strip, the structural element in the form of a thin layer having a first side and a second side, the structural element having a plurality of predetermined hole structures formed in the first side, the hole structures integral to a sacrificial material forming a bottom surface within each hole structure, the bottom surface a non-planar surface;
b.) positioning the structural element in a material deposition system, the vacuum system having a rotating surface, the structural element disposed so as to flexibly conform to the surface, the deposition system for forming an electrolytic layer over the hole structure and bottom surface, the electrolytic layer a solid oxide electrolyte;
c.) removing the sacrificial material so as to provide a free-standing electrolytic layer, the free-standing electrolytic layer characterized by be provided by the that the electrolytic layer remains disposed within each hole structure so as to be an effective gas barrier to a gas adjacent the through-holes;
d.) forming electrode layers on opposing sides of the electrolytic layer, wherein the electrode layers are disposed for enabling an electrolytic function.

9. The method of claim 8, wherein the electrolytic function is that of a gas separation device.

10. The method of claim 8, wherein the electrolytic function is that of a fuel cell device.
